(19) United States
(12) Patent Application Publication
(10) Pub. No.: US 2025/0068457 A1
(43) Pub. Date: Feb. 27, 2025

(54) COMPUTER VISION PIPELINE MANAGEMENT IN PROGRAMMABLE NETWORK INTERFACE DEVICE

(71) Applicant: Intel Corporation, Santa Clara, CA (US)

(72) Inventors: Marcos Carranza, Portland, OR (US); Karthik Kumar, Chandler, AZ (US); Mariano Ortega De Mues, Hillsboro, OR (US); Mateo Guzman, Beaverton, OR (US); Patrick Connor, Beaverton, OR (US); Cesar Martinez-Spessot, Hillsboro, OR (US)

(73) Assignee: Intel Corporation, Santa Clara, CA (US)

(21) Appl. No.: 18/944,987

(22) Filed: Nov. 12, 2024

(51) Int. Cl. G06F 9/455

(52) U.S. Cl. CPC G06F 9/45558; G06F 2009/45583

(57) ABSTRACT

An apparatus includes a host interface; a network interface; and a programmable circuitry communicably coupled to the host interface and the network interface, the programmable circuitry comprising one or more processors to implement network interface functionality and to: determine portions of a set of computer vision (CV) processes to be deployed on the programmable circuitry and a host device, wherein the host device to be communicably coupled to the programmable network interface device; access instructions to cause the portions of the set of the CV processes to be deployed on the host device and the programmable network interface device; and wherein a media processing portion of the set of the CV processes is to be deployed to the programmable circuitry, and wherein the programmable circuitry is to utilize media processing hardware circuitry hosted by the apparatus to perform the media processing portion.

### BACKGROUND OF THE DISCLOSURE

In highly virtualized environments, significant amounts of server resources are expended processing tasks that are beyond user applications. Such processing tasks can include hypervisors, container engines, network and storage functions, security, and large amounts of network traffic. To address these various processing tasks, programmable network interface devices with accelerators and network connectivity have been introduced. These programmable network interface devices are referred to as infrastructure processing units (IPUs), data processing units (DPUs), edge processing units (EPUs), programmable network devices, and so on. The programmable network interface devices can accelerate and manage infrastructure functions using dedicated and programmable cores deployed in the devices. The programmable network interface devices can provide for infrastructure offload and an extra layer of security by serving as a control point of the host for running infrastructure applications.

### BRIEF DESCRIPTION OF THE DRAWINGS

Embodiments described herein are illustrated by way of example and not limitation in the figures of the accompanying drawings in which like references indicate similar elements, and in which:

FIG. 1 is a block diagram illustrating a computer system configured to implement one or more aspects of the embodiments described herein;

FIG. 2 is a block diagram of a system that includes selected components of a datacenter;

FIG. 3 is a block diagram of a portion of a datacenter, according to one or more examples of the present specification;

FIG. 4A-4C illustrates programmable forwarding elements and adaptive routing;

FIG. 5A-5B depicts example network interface devices;

FIG. 6 is a block diagram illustrating a programmable network interface and data processing unit;

FIG. 7 is a block diagram illustrating an IP core development system;

FIG. 8 is a block diagram illustrating an example computing environment for providing for computer vision (CV) pipeline management in programmable network interface devices, according to implementations herein;

FIG. 9 is a block diagram of an example programmable network interface device for providing CV pipeline management in programmable network interface devices, in accordance with implementations herein;

FIG. 10 is a flow diagram illustrating an embodiment of a method for providing CV pipeline management in a programmable network interface device;

FIG. 11 is a flow diagram illustrating an embodiment of a method for providing a media processing portion of a CV pipeline in a programmable network interface device; and

FIG. 12 is a flow diagram illustrating an embodiment of a method for providing a decomposed portion of CV pipeline in a host device.

### DETAILED DESCRIPTION

In the following description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

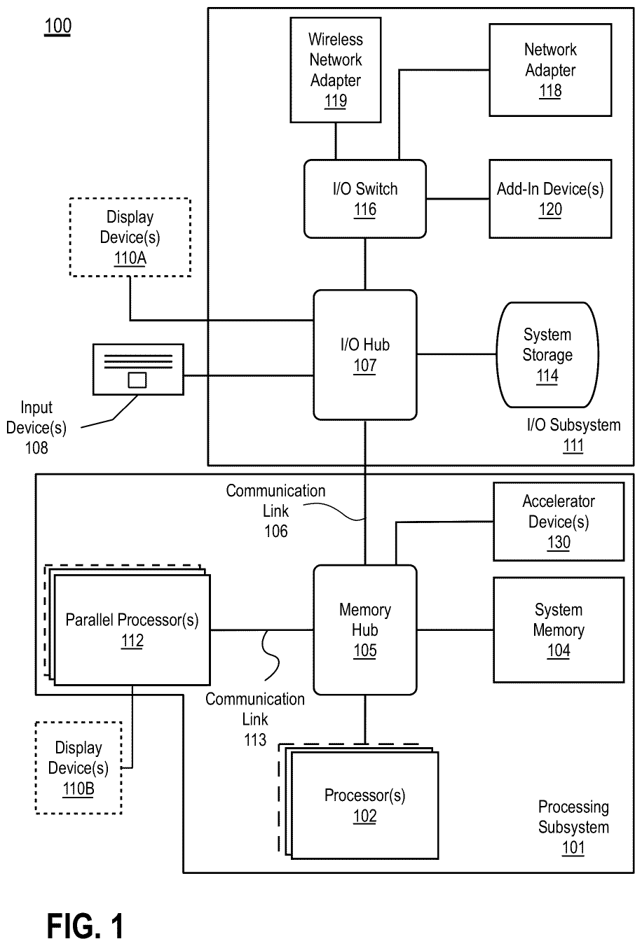

FIG. 1 is a block diagram illustrating a computing system 100 configured to implement one or more aspects of the embodiments described herein. The computing system 100 includes a processing subsystem 101 having one or more processor(s) 102 and a system memory 104 communicating via an interconnection path that may include a memory hub 105. The memory hub 105 may be a separate component within a chipset component or may be integrated within the one or more processor(s) 102. The memory hub 105 couples with an I/O subsystem 111 via a communication link 106. The I/O subsystem 111 includes an I/O hub 107 that can enable the computing system 100 to receive input from one or more input device(s) 108. Additionally, the I/O hub 107 can enable a display controller, which may be included in the one or more processor(s) 102, to provide outputs to one or more display device(s) 110A. In one embodiment the one or more display device(s) 110A coupled with the I/O hub 107 can include a local, internal, or embedded display device.

The processing subsystem 101, for example, includes one or more parallel processor(s) 112 coupled to memory hub 105 via a communication link 113, such as a bus or fabric. The communication link 113 may be one of any number of standards-based communication link technologies or protocols, such as, but not limited to PCI Express, or may be a vendor specific communications interface or communications fabric. The one or more parallel processor(s) 112 may form a computationally focused parallel or vector processing system that can include a large number of processing cores and/or processing clusters, such as a many integrated core (MIC) processor. For example, the one or more parallel processor(s) 112 form a graphics processing subsystem that can output pixels to one of the one or more display device(s) 110A coupled via the I/O hub 107. The one or more parallel processor(s) 112 can also include a display controller and display interface (not shown) to enable a direct connection to one or more display device(s) 110B.

Within the I/O subsystem 111, a system storage unit 114 can connect to the I/O hub 107 to provide a storage mechanism for the computing system 100. An I/O switch 116 can be used to provide an interface mechanism to enable connections between the I/O hub 107 and other components, such as a network adapter 118 and/or wireless network adapter 119 that may be integrated into the platform, and various other devices that can be added via one or more add-in device(s) 120. The add-in device(s) 120 may also include, for example, one or more external graphics processor devices, graphics cards, and/or compute accelerators. The network adapter 118 can be an Ethernet adapter or another wired network adapter. The wireless network adapter 119 can include one or more of a Wi-Fi, Bluetooth, near field communication (NFC), or other network device that includes one or more wireless radios.

The computing system 100 can include other components not explicitly shown, including USB or other port connections, optical storage drives, video capture devices, and the like, which may also be connected to the I/O hub 107. Communication paths interconnecting the various components in FIG. 1 may be implemented using any suitable protocols, such as PCI (Peripheral Component Interconnect) based protocols (e.g., PCI Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Ultra Ethernet Transport (UET), Ultra Accelerator Link (UALink), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe. In one embodiment, time-aware communication protocols are supported, including time-aware RDMA, time-aware NVME, and time-aware NVME-oF, in which a precise times and rate of data consumption is used to control the transfer of data.

The one or more parallel processor(s) 112 may incorporate circuitry for graphics and video processing, including, for example, video output circuitry, and constitutes a graphics processing unit (GPU). Alternatively or additionally, the one or more parallel processor(s) 112 can incorporate circuitry for general purpose processing, while preserving the underlying computational architecture, described in greater detail herein. Components of the computing system 100 may be integrated with one or more other system elements on a single integrated circuit. For example, the one or more parallel processor(s) 112, memory hub 105, processor(s) 102, and I/O hub 107 can be integrated into a system on chip (SoC) integrated circuit. Alternatively, the components of the computing system 100 can be integrated into a single package to form a system in package (SIP) configuration. In one embodiment at least a portion of the components of the computing system 100 can be integrated into a multi-chip module (MCM), which can be interconnected with other multi-chip modules into a modular computing system. An MCM or SIP configuration can include multiple integrated circuits, chiplets, dielets, tiles, or other circuit forms. The term chip may refer to a packaged die, while die may refer to a bare singulated instantiation of a chip design that is not packaged. However, the term chip and die are often used interchangeably in the art. When described herein, the term chiplet is intended to convey an at least partially packaged integrated circuit that may be integrated with other circuits in an MCM or SIP configuration.

In some configurations, the computing system 100 includes one or more accelerator device(s) 130 coupled with the memory hub 105, in addition to the processor(s) 102 and the one or more parallel processor(s) 112. The accelerator device(s) 130 are configured to perform domain specific acceleration of workloads to handle tasks that are computationally intensive or utilize high throughput. The accelerator device(s) 130 can reduce the burden placed on the processor(s) 102 and/or parallel processor(s) 112 of the computing system 100. The accelerator device(s) 130 can include but are not limited to smart network interface cards, data processing units, cryptographic accelerators, storage accelerators, artificial intelligence (AI) accelerators, compression units, neural processing units (NPUs), storage accelerators, and/or video transcoding accelerators.

It will be appreciated that the computing system 100 shown herein is illustrative and that variations and modifications are possible. The connection topology, including the number and arrangement of bridges, the number of processor(s) 102, and the number of parallel processor(s) 112, may be modified as desired. For instance, system memory 104 can be connected to the processor(s) 102 directly rather than through a bridge, while other devices communicate with system memory 104 via the memory hub 105 and the processor(s) 102. In other alternative topologies, the parallel processor(s) 112 are connected to the I/O hub 107 or directly to one of the one or more processor(s) 102, rather than to the memory hub 105. In other embodiments, the I/O hub 107 and memory hub 105 may be integrated into a single chip. It is also possible that two or more sets of processor(s) 102 are attached via multiple sockets, which can couple with two or more instances of the parallel processor(s) 112.

Some of the particular components shown herein are optional and may not be included in all implementations of the computing system 100. For example, any number of add-in cards or peripherals may be supported, or some components may be eliminated. Furthermore, some architectures may use different terminology for components similar to those illustrated in FIG. 1.

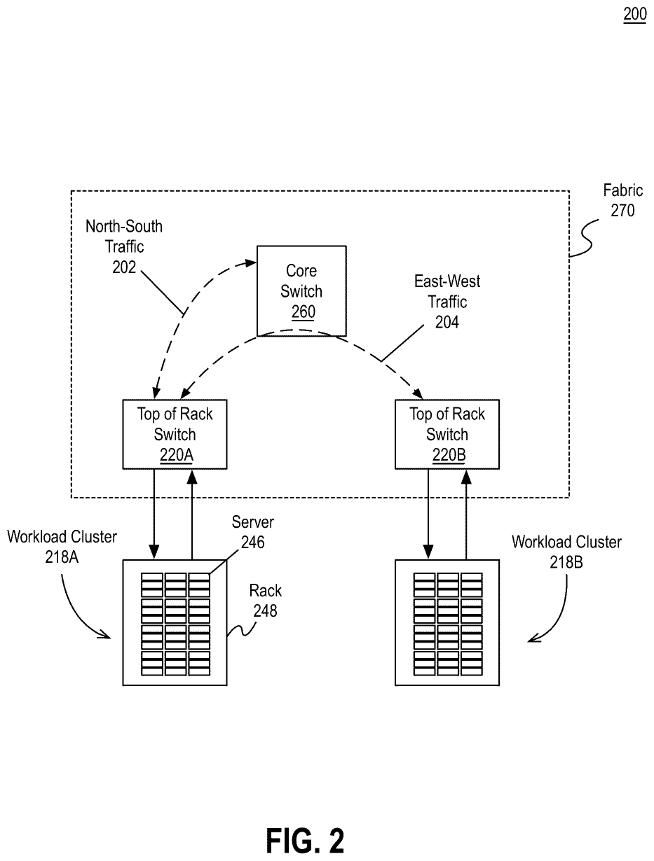

FIG. 2 is a block diagram of a system 200 that includes selected components of a datacenter. The components of the illustrated datacenter may reside, for example within a cloud service provider (CSP), or another datacenter, which may be, by way of nonlimiting example, a traditional enterprise datacenter, an enterprise “private cloud,” or a “public cloud,” providing services such as infrastructure as a service (IaaS), platform as a service (PaaS), or software as a service (SaaS). The system 200 includes some number of workload clusters, including but not limited to workload cluster 218A and workload cluster 218B. The workload clusters may be clusters of individual servers, blade servers, rackmount servers, or any other suitable server topology.

The system 200 may include workload clusters 218A-218B. A workload cluster 218A-218B can include a rack 248 that houses multiple servers (e.g., server 246). The rack 248 and the servers of the workload clusters 218A-218B may conform to the rack unit (“U”) standard, in which one rack unit conforms to a 19 inch wide rack frame and a full-sized industry standard rack accommodates 42 units (42 U) of equipment. One unit (1 U) of equipment (e.g., a 1 U server) may be 1.75 inches high and approximately 36 inches deep. In various configurations, compute resources such as processors, memory, storage, accelerators, and switches may fit into some multiple of rack units within a rack 248.

The server 246 may host a standalone operating system configured to provide server functions, or the servers may be virtualized. A virtualized server may be under the control of a virtual machine manager (VMM), hypervisor, and/or orchestrator, and may host one or more virtual machines, virtual servers, or virtual appliances. The workload clusters 218A-218B may be collocated in a single datacenter, or may be located in different geographic datacenters. Depending on the contractual agreements, some servers may be specifically dedicated to certain enterprise clients or tenants while other servers may be shared.

The various devices in a datacenter may be connected to one other via a switching fabric 270, which may include one or more high speed routing and/or switching devices. The switching fabric 270 may provide north-south traffic 202 (e.g., traffic to and from the wide area network (WAN), such as the internet), and east-west traffic 204 (e.g., traffic across the datacenter). Historically, north-south traffic 202 accounted for the bulk of network traffic, but as web services become more complex and distributed, the volume of east-west traffic 204 has risen. In many datacenters, east-west traffic 204 now accounts for the majority of traffic. Furthermore, as the capability of the server 246 increases, traffic volume may further increase. For example, the server 246 may provide multiple processor slots, with a slot accommodating a processor having four to eight cores, along with sufficient memory for the cores. Thus, the server 246 may host a number of VMs, which may be a source of traffic generation.

To accommodate the large volume of traffic in a datacenter, a highly capable implementation of the switching fabric 270 may be provided. The illustrated implementation of the switching fabric 270 is an example of a flat network in which the server 246 may have a direct connection to a top-of-rack switch (ToR switch 220A-220B) (e.g., a “star” configuration). ToR switch 220A can connect with workload cluster 218A, while ToR switch 220B can connect with workload cluster 218B. The ToR switch 220A-220B may couple to a core switch 260. This two-tier flat network architecture is shown as an illustrative example and other architectures may be used, such as three-tier star or leaf-spine (also called “fat tree” topologies) based on the “Clos” architecture, hub-and-spoke topologies, mesh topologies, ring topologies, or 3-D mesh topologies, by way of nonlimiting example.

The switching fabric 270 may be provided by any suitable interconnect using any suitable interconnect protocol. For example, the server 246 may include a fabric interface (FI) of some type, a network interface card (NIC), or other host interface. The host interface itself may couple to one or more processors via an interconnect or bus, such as PCI, PCIe, or similar, and in some cases, this interconnect bus may be considered to be part of the switching fabric 270. The switching fabric may also use PCIe physical interconnects to implement more advanced protocols, such as compute express link (CXL).

The interconnect technology may be provided by a single interconnect or a hybrid interconnect, such as where PCIe provides on-chip communication, 1 Gb or 10 Gb copper Ethernet provides relatively short connections to a ToR switch 220A-220B, and optical cabling provides relatively longer connections to core switch 260. Interconnect technologies include, by way of nonlimiting example, Ultra Path Interconnect (UPI), FibreChannel, Ethernet, FibreChannel over Ethernet (FCoE), InfiniBand, PCIe, NVLink, or fiber optics, to name just a few. Some of these will be more suitable for certain deployments or functions than others, and selecting an appropriate fabric for the instant application is an exercise of ordinary skill.

In one embodiment, the switching elements of the switching fabric 270 are configured to implement switching techniques to improve the performance of the network in high usage scenarios. Example advanced switching techniques include but are not limited to adaptive routing, adaptive fault recovery, and adaptive and/or telemetry-based congestion control.

Adaptive routing enables a ToR 220A-220B switch and/or core switch 260 to select the output port to which traffic is switched based on the load on the selected port, assuming unconstrained port selection is enabled. An adaptive routing table can configure the forwarding tables of switches of the switching fabric 270 to select between multiple ports between switches when multiple connections are present between a given set of switches in an adaptive routing group. Adaptive fault recovery (e.g., self-healing) enables the automatic selection of an alternate port if the ported selected by the forwarding table port is in a failed or inactive state, which enables rapid recovery in the event of a switch-to-switch port failure. A notification can be sent to neighboring switches when adaptive routing or adaptive fault recovery becomes active in a given switch. Adaptive congestion control configures a switch to send a notification to neighboring switches when port congestion on that switch exceeds a configured threshold, which may cause those neighboring switches to adaptively switch to uncongested ports on that switch or switches associated with an alternate route to the destination.

Telemetry-based congestion control uses real-time monitoring of telemetry from network devices, such as switches within the switching fabric 270, to detect when congestion will begin to impact the performance of the switching fabric 270 and proactively adjust the switching tables within the network devices to prevent or mitigate the impending congestion. A ToR 220A-220B switch and/or core switch 260 can implement a built-in telemetry-based congestion control algorithm or can provide an API though which a programmable telemetry-based congestion control algorithm can be implemented. A continuous feedback loop may be implemented in which the telemetry-based congestion control system continuously monitors the network and adjusts the traffic flow in real-time based on ongoing telemetry data. Learning and adaptation can be implemented by the telemetry-based congestion control system in which the system can adapt to changing network conditions and improve its congestion control strategies based on historical data and trends.

Note however that while high-end fabrics are provided herein by way of illustration, more generally, the switching fabric 270 may include any suitable interconnect or bus for the particular application, including legacy interconnects used to implement a local area network (LANs), synchronous optical networks (SONET), asynchronous transfer mode (ATM) networks, wireless networks such as Wi-Fi and Bluetooth, 5G wireless, DSL interconnects, MOCA, or similar. It is also expressly anticipated that in the future, new network technologies will arise to supplement or replace some of those listed here, and any such future network topologies and technologies can be or form a part of the switching fabric 270.

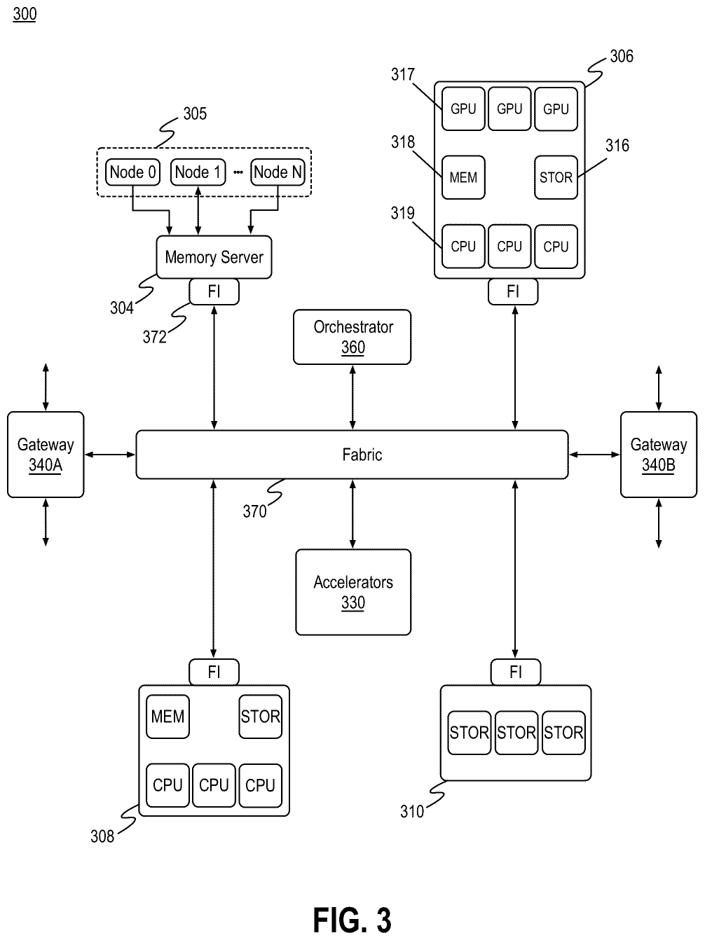

FIG. 3 is a block diagram of a portion of a datacenter 300, according to one or more examples included within the present specification. The illustrated portion of the datacenter 300 is not intended to include all components of a datacenter. The illustrated portion may be duplicated multiple times within the datacenter 300 and/or the datacenter 300 may include portions beyond the illustrated portions, depending on the capacity and functionality intended to be provided by the datacenter 300. The datacenter 300 may be, in various embodiments include components of the datacenter of the system 200 of FIG. 2, or may be a different datacenter.

The datacenter 300 includes a number of logic elements forming a plurality of nodes, where the nodes may individually be provided by a physical server, a group of servers, or other hardware. The server may also host one or more virtual machines, as appropriate to its application. A fabric 370 is provided to interconnect various aspects of datacenter 300. The fabric 370 may be provided by any suitable interconnect technology, including but not limited to InfiniBand, Ethernet, PCIe, or CXL. The fabric 370 of the datacenter 300 may be a version of and/or include elements of the switching fabric 270 of the system 200 of FIG. 2. The fabric 370 of datacenter 300 can interconnect datacenter elements that include server nodes (e.g., memory server node 304, heterogenous compute server node 306, CPU server node 308, storage server node 310), accelerators 330, gateways 340A-340B to other fabrics, fabric architectures, or interconnect technologies, and an orchestrator 360.

The server nodes of the datacenter 300 can include but are not limited to a memory server node 304, a heterogenous compute server node 306, a CPU server node 308, and a storage server node 310. The heterogenous compute server node 306 and a CPU server node 308 can perform independent operations for different tenants or cooperatively perform operations for a single tenant. The heterogenous compute server node 306 and a CPU server node 308 can also host virtual machines that provide virtual server functionality to tenants of the datacenter.

The individual server nodes can connect with the fabric 370 via a fabric interface 372. The specific type of fabric interface 372 that is used depends at least in part on the technology or protocol that is used to implement the fabric 370. For example, where the fabric 370 is an Ethernet fabric, the individual fabric interface 372 may be an Ethernet network interface controller. Where the fabric 370 is a PCIe-based fabric, the fabric interfaces may be PCIe-based interconnects. Where the fabric 370 is an InfiniBand fabric, the fabric interface 372 of the heterogenous compute server node 306 and a CPU server node 308 may be a host channel adapter (HCA), while the fabric interface 372 of the memory server node 304 and storage server node 310 may be a target channel adapter (TCA). TCA functionality may be an implementation-specific subset of HCA functionality. The various fabric interfaces may be implemented as intellectual property (IP) blocks that can be inserted into an integrated circuit as a modular unit, as can other circuitry within the datacenter 300.

The heterogenous compute server node 306 includes multiple CPU sockets, which can house a CPU 319, and which may be, but is not limited to an Intel® Xeon™ processor including a plurality of cores. The CPU 319 may also be, for example, a multi-core datacenter class ARM@CPU, such as an NVIDIA® Grace™ CPU. The heterogenous compute server node 306 includes memory devices 318 to store data for runtime execution and storage devices 316 to enable the persistent storage of data within non-volatile memory devices. The heterogenous compute server node 306 is enabled to perform heterogenous processing via the presence of GPUs (e.g., GPU 317), which can be used, for example, to perform high-performance compute (HPC), media server, cloud gaming server, and/or machine learning compute operations. In one configuration, the GPUs may be interconnected with one other and CPUs of the heterogenous compute server node 306 via interconnect technologies such as PCIe, CXL, or NVLink.

The CPU server node 308 includes a plurality of CPUs (e.g., CPU 319), memory (e.g., memory devices 318) and storage (storage devices 316) to execute applications and other program code that provide server functionality, such as web servers or other types of functionality that is remotely accessible by clients of the CPU server node 308. The CPU server node 308 can also execute program code that provides services or micro-services that enable complex enterprise functionality. The fabric 370 will be provisioned with sufficient throughput to enable the CPU server node 308 to be simultaneously accessed by a large number of clients, while also retaining sufficient throughput for use by the heterogenous compute server node 306 and to enable the use of the memory server node 304 and the storage server node 310 by the heterogenous compute server node 306 and the CPU server node 308. Furthermore, in one configuration, the CPU server node 308 may rely primarily on distributed services provided by the memory server node 304 and the storage server node 310, as the memory and storage of the CPU server node 308 may not be sufficient for all of the operations intended to be performed by the CPU server node 308. Instead, a large pool of high-speed or specialized memory may be dynamically provisioned between a number of nodes, so that a node has access to a large pool of resources, but those resources do not sit idle when that particular node does not utilize them. A distributed architecture of this type is possible due to the high speeds and low latencies provided by the fabric 370 of contemporary datacenters and may be advantageous because resources do not have to be over-provisioned for the individual server node.

The memory server node 304 can include memory nodes 305 having memory technologies that are suitable for the storage of data used during the execution of program code by the heterogenous compute server node 306 and the CPU server node 308. The memory nodes 305 can include volatile memory modules, such as DRAM modules, and/or non-volatile memory technologies that can operate similar to DRAM speeds (e.g., 3D XPoint memory), such that those modules have sufficient throughput and latency performance metrics to be used as a tier of system memory at execution runtime. The memory server node 304 can be linked with the heterogenous compute server node 306 and/or CPU server node 308 via technologies such as CXL.mem, which enables memory access from a host to a device. In such configuration, a CPU 319 of the heterogenous compute server node 306, a CPU server node 308 can link to the memory server node 304 and access the memory nodes 305 of the memory server node 304 in a similar manner as, for example, the CPU 319 of the heterogenous compute server node 306 can access device memory of a GPU within the heterogenous compute server node 306. For example, the memory server node 304 may provide remote direct memory access (RDMA) to the memory nodes 305, in which, for example, the CPU server node 308 may access memory resources on the memory server node 304 via the fabric 370 using DMA operations, in a similar manner as how the CPU would access its own onboard memory.

The memory server node 304 can be used by the heterogenous compute server node 306 and CPU server node 308 to expand the runtime memory that is available during memory-intensive activities such as the training of machine learning models. A tiered memory system can be enabled in which model data can be swapped into and out of the memory devices 318 of the heterogenous compute server node 306 to memory of the memory server node 304 at higher performance and/or lower latency than local storage (e.g., storage devices 316). During workload execution setup, the entire working set of data may be loaded into one or more of the memory nodes 305 of the memory server node 304 and loaded into the memory devices 318 of the heterogenous compute server node 306 during execution of a heterogenous workload.

The storage server node 310 provides storage functionality to the heterogenous compute server node 306, the CPU server node 308, and potentially the memory server node 304. The storage server node 310 may provide a networked bunch of disks (NBOD), program flash memory (PFM), redundant array of independent disks (RAID), redundant array of independent nodes (RAIN), network attached storage (NAS), or other nonvolatile memory solutions. In one configuration, the storage server node 310 can couple with the heterogenous compute server node 306, the CPU server node 308, and/or the memory server node 304 such as NVMe-oF, which enables the NVME protocol to be implemented over the fabric 370. In such configurations, the fabric interface 372 of those servers may be smart interfaces that include hardware to accelerate NVMe-oF operations.

The accelerators 330 within the datacenter 300 can provide various accelerated functions, including hardware or coprocessor acceleration for functions such as packet processing, encryption, decryption, compression, decompression, network security, or other accelerated functions in the datacenter. In some examples, accelerators 330 may include deep learning accelerators, such as neural processing units (NPU), that can receive offload of matrix multiply operations of other neural network operations from the heterogenous compute server node 306 or the CPU server node 308. In some configurations, the accelerators 330 may reside in a dedicated accelerator server or distributed throughout the various server nodes of the datacenter 300. For example, an NPU may be directly attached to one or more CPU cores within the heterogenous compute server node 306 or the CPU server node 308. In some configurations, the accelerators 330 can include or be included within smart network controllers, infrastructure processing units (IPUs), or data processing units, which combine network controller functionality with accelerator, processor, or coprocessor functionality.

In one configuration, the datacenter 300 can include gateways 340A-340B from the fabric 370 to other fabrics, fabric architectures, or interconnect technologies. For example, where the fabric 370 is an InfiniBand fabric, the gateways 340A-340B may be gateways to an Ethernet fabric. Where the fabric 370 is an Ethernet fabric, the gateways 340A-340B may include routers to route data to other portions of the datacenter 300 or to a larger network, such as the Internet. For example, a first gateway 340A may connect to a different network or subnet within the datacenter 300, while a second gateway 340B may be a router to the Internet.

The orchestrator 360 manages the provisioning, configuration, and operation of network resources within the datacenter 300. The orchestrator 360 may include hardware or software that executes on a dedicated orchestration server. The orchestrator 360 may also be embodied within software that executes, for example, on the CPU server node 308 that configures software defined networking (SDN) functionality of components within the datacenter 300. In various configurations, the orchestrator 360 can enable automated provisioning and configuration of components of the datacenter 300 by performing network resource allocation and template-based deployment. Template-based deployment is a method for provisioning and managing IT resources using predefined templates, where the templates may be based on standard templates utilized by the government, service provider, financial, standard or customer. The template may also dictate service level agreements (SLA) or service level obligations (SLO). The orchestrator 360 can also perform functionality including but not limited to load balancing and traffic engineering, network segmentation, security automation, real-time telemetry monitoring, and adaptive switching management, including telemetry-based adaptive switching. In some configurations, the orchestrator 360 can also provide multi-tenancy and virtualization support by enabling virtual network management, including the creation and deletion of virtual LANs (VLANs) and virtual private networks (VPNs), and tenant isolation for multi-tenant datacenters.

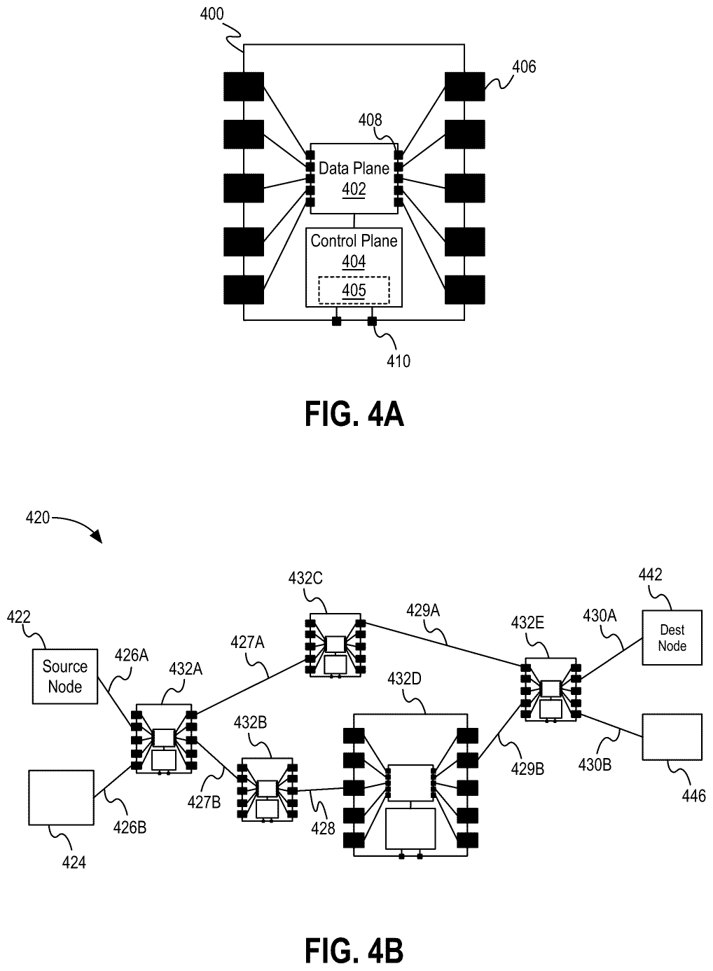

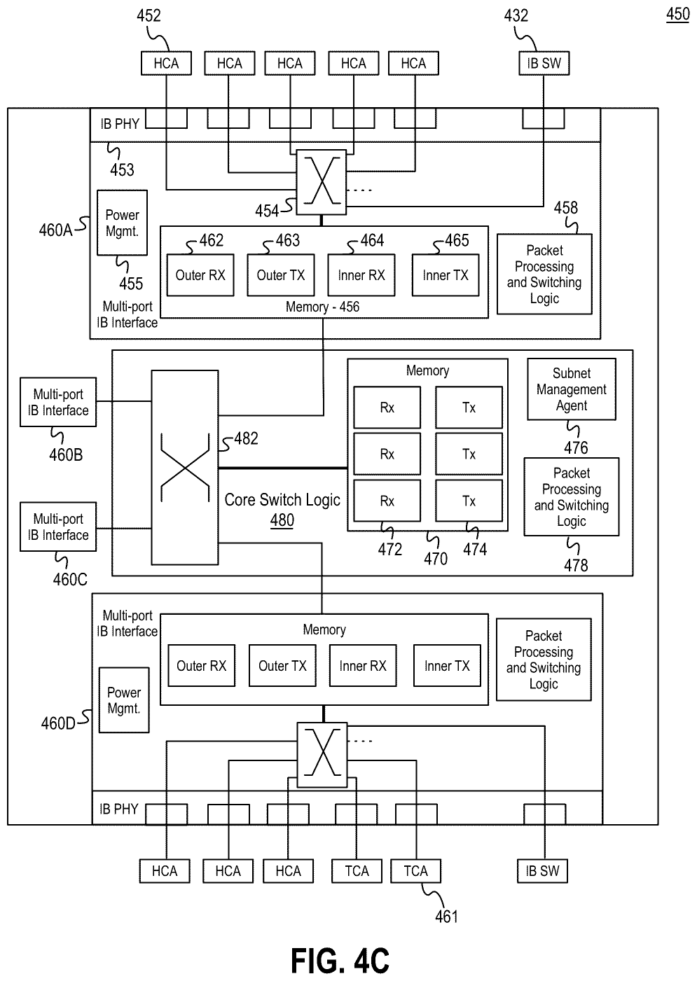

FIG. 4A-4C illustrates programmable forwarding elements and adaptive routing. FIG. 4A illustrates a forwarding element that includes a control plane and a programmable data plane. FIG. 4B illustrates a network having switching devices configured to perform adaptive routing and telemetry-based congestion control. FIG. 4C illustrates an InfiniBand switch including multi-port IB interfaces.

FIG. 4A shows a forwarding element 400 that can be configured to forward data messages within a network based on a program provided by a user. The program, in some embodiments, includes instructions for forwarding data messages, as well as performing other processes such as firewall, denial of service attack protection, and load balancing operations. The forwarding element 400 can be any type of forwarding element, including but not limited to a switch, a switch chip, a router, or a bridge. The forwarding element 400 can forward data messages associated with various technologies, such as but not limited to Ethernet, Ultra Ethernet, InfiniBand, or NVLink.

In various network configurations, the forwarding element is deployed as a non-edge forwarding element in the interior of the network to forward data messages from a source device to a destination device. In network configurations, the forwarding element 400 is deployed as an edge forwarding element at the edge of the network to connect to compute devices (e.g., standalone or host computers) that serve as sources and destinations of the data messages. As a non-edge forwarding element, the forwarding element 400 forwards data messages between forwarding elements in the network, such as through an intervening network fabric. As an edge forwarding element, the forwarding element 400 forwards data messages to and from edge compute devices to one other, to other edge forwarding elements and/or to non-edge forwarding elements.

The forwarding element 400 includes circuitry to implement a data plane 402 that performs the forwarding operations of the forwarding element 400 to forward data messages received by the forwarding element to other devices. The forwarding element 400 also includes circuitry to implement a control plane 404 that configures the data plane circuit. Additionally, the forwarding element 400 includes physical ports 406 that receive data messages from, and transmit data messages to, devices outside of the forwarding element 400. The data plane 402 includes ports 408 that receive data messages from the physical ports 406 for processing. The data messages are processed and forwarded to another port on the data plane 402, which is connected to another physical port of the forwarding element 400. In addition to being associated with physical ports of the forwarding element 400, some of the ports 408 on the data plane 402 may be associated with other modules of the data plane 402.

The data plane includes programmable packet processor circuits that provide several programmable message-processing stages that can be configured to perform the data-plane forwarding operations of the forwarding element 400 to process and forward data messages to their destinations. These message-processing stages perform these forwarding operations by processing data tuples (e.g., message headers) associated with data messages received by the data plane 402 in order to determine how to forward the messages. The message-processing stages include match-action units (MAUs) that try to match data tuples (e.g., header vectors) of messages with table records that specify action to perform on the data tuples. In some embodiments, table records are populated by the control plane 404 and are not known when configuring the data plane to execute a program provided by a network user. The programmable message-processing circuits are grouped into multiple message-processing pipelines. The message-processing pipelines can be ingress or egress pipelines before or after the forwarding element's traffic management stage that directs messages from the ingress pipelines to egress pipelines.

The specifics of the hardware of the data plane 402 depends on the communication protocol implemented via the forwarding element 400. Ethernet switches use application specific integrated circuits (ASICs) designed to handle Ethernet frames and the TCP/IP protocol stack. These ASICs are configured for a broad range of traffic types, including unicast, multicast, and broadcast. Ethernet switch ASICs are generally designed to balance cost, power consumption, and performance, although high-end Ethernet switches may support more advanced features such as deep packet inspection and advanced QoS (Quality of Service). InfiniBand switches use specialized ASICs designed for ultra-low latency and high throughput. These ASICs enable features configured for handling the InfiniBand protocol and provide support for RDMA and other features that utilize precise timing and high-speed data processing, although high-end Ethernet switches may support RoCE (RDMA over Converged Ethernet), which offers similar benefits to InfiniBand but with higher latency compared to native InfiniBand RDMA.

The forwarding element 400 may also be configured as an NVLink switch (e.g., NVSwitch), which is used to interconnect multiple graphics processors via the NVLink connection protocol. When configured as an NVLink switch, the forwarding element 400 can provide GPU servers with increased GPU to GPU bandwidth relative to GPU servers interconnected via InfiniBand. An NVLink switch can reduce network traffic hotspots that may occur when interconnected GPU-equipped servers execute operations such as distributed neural network training.

In general, where the data plane 402, in concert with a program executed on the data plane 402 (e.g., a program written in the P4 language), performs message or packet forwarding operations for incoming data, the control plane 404 determines how messages or packets should be forwarded. The behavior of a program executed on the data plane 402 is determined in part by the control plane 404, which populates match-action tables with specific forwarding rules. The forwarding rules that are used by the program executed on the data plane 402 are independent of the data plane program itself. In one configuration, the control plane can couple with a management port 410 that enables administrator configuration of the forwarding element 400. The data connection that is established via the management port 410 is separate from the data connections for ingress and egress data ports. In one configuration, the management ports 410 may connect with a management plane 405, which facilitates administrative access to the device, enables the analysis of device state and health, and enables device reconfiguration. The management plane 405 may be a portion of the control plane 404 or in direct communication with the control plane 404. In one implementation, there is no direct access for the administrator to components of the control plane 404. Instead, information is gathered by the management plane 405 and the changes to the control plane 404 are carried out by the management plane 405.

FIG. 4B shows a network 420 having switches 432A-432E with support for adaptive routing and telemetry-based congestion control. The network 420 can be implemented using a variety of communication protocols described herein. In one embodiment, the network 420 is implemented using the InfiniBand protocol. In one embodiment, the network 420 is an Ethernet, converged Ethernet, or Ultra Ethernet network. The network 420 may include aspects of the fabric 370 of FIG. 3. The switches 432A-432E may be an implementation of the forwarding element 400 of FIG. 4A. The network 420 provides packet-based communication for multiple nodes (e.g., node 424, node 446), including a source node 422 and a destination node 442 of a data transfer to be performed over the network 420. Packets of a flow are forwarded over a route through the network 420 that traverses the switches (switch 432A-432E) and links (link 426A-426B, 427A-427B, 428, 429A-429B, 430A-430B) of the network 420. In an InfiniBand application, the switches and links belong to a certain InfiniBand subnet that is managed by a Subnet Manager (SM), which may be included within one of the switches (e.g., switch 432D). The source node 422 and the destination node 442 are the source and destination nodes for an example dataflow. Depending on the configuration of the network 420, packets may flow from any node to any other node via one or more paths.

The switches 432A-432E include a data plane 402, a control plane 404, a management plane 405, and physical ports 406, as in the forwarding element 400 of FIG. 4A. A processor of the control plane 404 can be used to implement adaptive routing techniques to adjust a route between the source node 422 and the destination node 442 based on the current state of the network. During network operation, the route from the source node 422 to the destination node 442 may at some point become unsuitable or compromised in its ability to transfer packets due to various events, such as congestion, link fault, or head-of-line blocking. Should such scenario occur, the switched 432A-432E can be configured to dynamically adapt the route of the packets that flow along a compromised path.

An adaptive routing (AR) event may be detected by one of the switches along a route that becomes compromised, for example, when the switch when it attempts to output packets on a designated output port. For example, an example data from the source node 422 to the destination node 442 can traverse links through switches of the network. An AR event may be detected by switch 432D for link 429B, for example, in response to congestion or a link fault associated with link 429B. Upon detecting the AR event, switch 432D, as the detecting switch, generates an adaptive routing notification (ARN), which has an identifier that distinguishes an ARN packet from other packet types. In various embodiments, the ARN includes parameters such as an identifier for the detecting switch, the type of AR event, and the source and destination address of the flow that triggered the AR event, and/or any other suitable parameters. The detecting switch sends the ARN backwards along the route to the preceding switches. The ARN may include a request for notified switches to modify the route to avoid traversal of the detected switch. The notified switches can then evaluate whether its routes may be modified to bypass the detecting switch. Otherwise, the switch forwards the ARN to the previous preceding switch along the route. In this scenario, switch 432B is not able to avoid switch 432D and will relay the ARN to switch 432A. Switch 432A can determine to adapt the route to the destination node 442 by using link 427A to switch 432C. Switch 432C can reach switch 432E via link 429A, allowing packets from the source node 422 to reach the destination node 442 while bypassing the AR event related to link 429B.

In various configurations, the network 420 can also adapt to congestion scenarios via programmable data planes within the switches 432A-432E that are able to execute data plane programs to implement in-network congestion control algorithms (CCAs) for TCP over Ethernet-based fabrics. Using in-band network telemetry (INT), programmable data planes within the switches 432A-432E can become aware when a port or link along a route is becoming congested and preemptively seek to route packets over alternate paths. For example, switch 432A can load balance traffic to the destination node 442 between link 427A and link 427B based on the level of congestion seen on the routes downstream from those links.

FIG. 4C shows an InfiniBand switch 450, which may be an implementation of the forwarding element 400 of FIG. 4A. The InfiniBand switch 450 includes a programmable data plane and is configurable to perform adaptive routing and telemetry-based congestion control as described herein. The InfiniBand switch 450 includes multi-port IB interfaces 460A-460D and core switch logic 480. The multi-port IB interfaces 460A-460D includes multiple ports. In one embodiment, a single instance of a physical interface (IB PHY 453) is present, with input and output buffers associated with the ports. In one embodiment, the ports have separate physical interfaces. The ports can couple with, for example, an HCA 452, a TCA 461, or another InfiniBand switch 432. The multi-port IB interfaces 460A-460D include a crossbar switch 454 that is configured to selectively couple input and output port buffers to local memory 456. The crossbar switch 454 is a non-blocking crossbar switch that provides direct and low latency switching with a fixed or variable packet size.

The local memory 456 includes multiple queues, including an outer receive queue 462, an outer transmit queue 463, an inner receive queue 464, and an inner transmit queue 465. The outer queues are used for data that is received at a given multi-port IB interface that is to be forwarded back out the same multi-port IB interface. The inner queues are used for data that is forwarded out a different multi-port IB interface than used to receive the data. Other types of queue configurations may be implemented in local memory 456. For example, different queues may be present to support multiple traffic classes, either on an individual port basis, shared port basis, or a combination thereof. The multi-port IB interfaces 460A-460D include power management circuitry 455, which can adjust a power state of circuitry within the respective multi-port IB interface. Additionally power management logic that performs similar operations may be implemented as part of core switch logic.

The multi-port IB interfaces 460A-460D include packet processing and switching logic 458, which is generally used to perform aspects of packet processing and/or switching operations that are performed at the local multi-port level rather than across the IB switch as a whole. Depending on the implementation, the packet processing and switching logic 458 can be configured to perform a subset of the operations of the packet processing and switching logic 478 within the core switch logic 480, or can be configured with the full functionality of the packet processing and switching logic 478 within the core switch logic 480. The processing functionality of the packet processing and switching logic 458 may vary, depending on the complexity of the operations and/or speed the operations are to be performed. For example, the packet processing and switching logic 458 can include processors ranging from microcontrollers to multi-core processors. A variety of types or architectures of multi-core processors may also be used. Additionally, a portion of the packet processing operations may be implemented by embedded hardware logic.

The core switch logic 480 includes a crossbar 482, memory 470, a subnet management agent (SMA 476), and packet processing and switching logic 478. The crossbar 482 is a non-blocking low latency crossbar that interconnects the multi-port IB interfaces 460A-460D and connects with the memory 470. The memory 470 includes receive queues 472 and transmit queues 474. In one embodiment, packets to be switched between the multi-port IB interfaces 460A-460D can be received by the crossbar 482, stored in one of the receive queues 472, processed by the packet processing and switching logic 478, and stored in a transmit queues 474 for transmission to the outbound multi-port IB interface. In implementations that do not use the multi-port IB interfaces 460A-460D, the core switch logic 480 and crossbar 482 switches packets directly between I/O buffers associated with the ports with the receive queues 472 and transmit queues 474 within the memory 470.

The packet processing and switching logic 478 includes programmable functionality and can execute data plane programs via a variety of types or architectures of multi-core processors. The packet processing and switching logic 478 is representative of the applicable circuitry and logic for implementing switching operations, as well as packet processing operations beyond which may be performed at the ports themselves. Processing elements of the packet processing and switching logic 478 executes software and/or firmware instructions configured to implement packet processing and switch operations. Such software and/or firmware may be stored in non-volatile storage on the switch itself. The software may also be downloaded or updated over a network in conjunction with initializing operations of the InfiniBand switch 450.

The SMA 476 is configurable to manage, monitor, and control functionality of the InfiniBand switch 450. The SMA 476 is also an agent of and in communication of the subnet manager (SM) for the subnet associated with the InfiniBand switch 450. The SM is the entity that discovers the devices within the subnet and performs a periodic sweep of the subnet to detect changes to the subnet's topology. One SMA within a subnet can be elected the primary SMA for the subnet and act as the SM. Other SMAs within the subnet will then communicate with that SMA. Alternatively, the SMA 476 can operate with other SMAs in the subnet to act as a distributed SM. In some embodiments, SMA 476 includes or executes on standalone circuitry and logic, such as a microcontroller, single core processor, or multi-core processor. In other embodiments, SMA 476 is implemented via software and/or firmware instructions executed on a processor core or other processing element that is part of a processor or other processing element used to implement packet processing and switching logic 478.

Embodiments are not specifically limited to implementations including multi-port IB interfaces 460A-460D. In one embodiment, a port is associated with its own receive and transmit buffers, with the crossbar 482 being configured to interconnect those buffers with receive queues 472 and transmit queues 474 in the memory 470. Packet processing and switching is then primarily performed by the packet processing and switching logic 478 of the core switch logic 480.

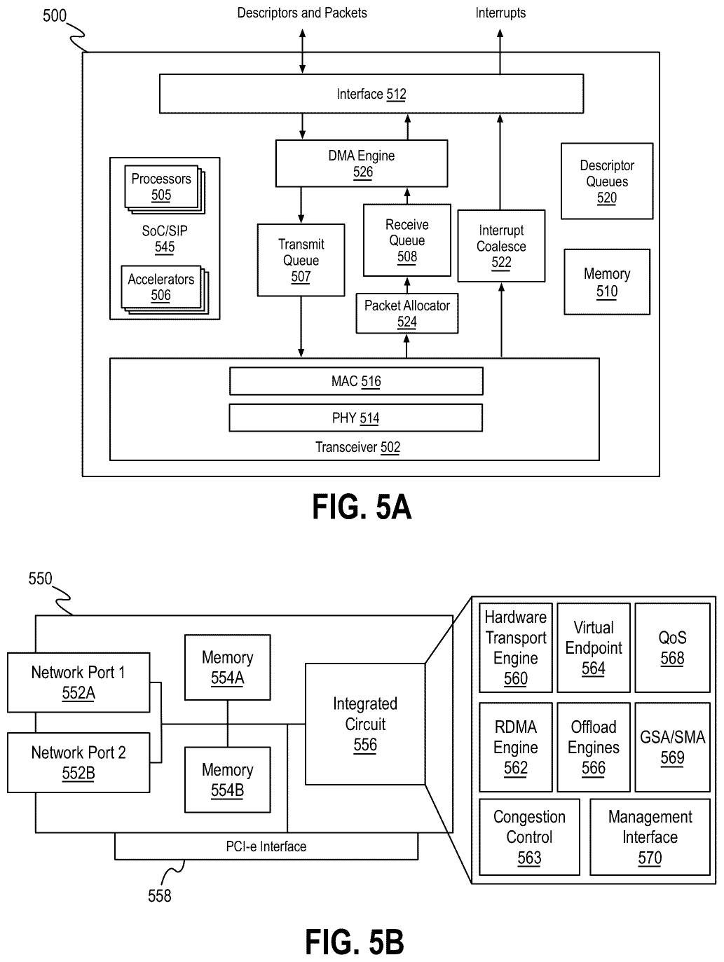

FIG. 5A-5B depict example network interface devices. FIG. 5A illustrates a network interface device 500 that may be configured as a smart Ethernet device. FIG. 5B illustrates a network interface device 550 which may be configured as an InfiniBand channel adapter.

As shown in FIG. 5A, in one configuration, the network interface device 500 can include a transceiver 502, transmit queue 507, receive queue 508, memory 510, and bus interface 512, and DMA engine 526. The network interface device 500 can also include an SoC/SIP 545, which includes processors 505 to implement smart network interface device functionality, as well as accelerators 506 for various accelerated functionality, such as NVMe-oF or RDMA. The specific makeup of the network interface device 500 depends on the protocol implemented via the network interface device 500.

In various configurations, the network interface device 500 is configurable to interface with networks including but not limited to Ethernet, including Ultra Ethernet. However, the network interface device 500 may also be configured as an InfiniBand or NVLink interface via the modification of various components. For example, the transceiver 502 can be capable of receiving and transmitting packets in conformance with the InfiniBand, Ethernet, or NVLink protocols. Other protocols may also be used. The transceiver 502 can receive and transmit packets from and to a network via a network medium. The transceiver 502 can include PHY circuitry 514 and media access control circuitry (MAC circuitry 516). PHY circuitry 514 can include encoding and decoding circuitry to encode and decode data packets according to applicable physical layer specifications or standards. MAC circuitry 516 can be configured to assemble data to be transmitted into packets, that include destination and source addresses along with network control information and error detection hash values.

The SoC/SIP 545 can include processors that may be any a combination of a CPU processor, graphics processing unit (GPU), field programmable gate array (FPGA), application specific integrated circuit (ASIC), or other hardware devices configurable for instruction execution. For example, a smart network interface can provide packet processing capabilities in the network interface using processors 505. Configuration of operation of processors 505, including programmable data plane processors, can be programmed using Programming Protocol-independent Packet Processors (P4), C, Python, Broadcom Network Programming Language (NPL), x86, or ARM compatible executable binaries or other executable binaries.

The packet allocator 524 can provide distribution of received packets for processing by multiple CPUs or cores using timeslot allocation. An interrupt coalesce circuit 522 can perform interrupt moderation in which the interrupt coalesce circuit 522 waits for multiple packets to arrive, or for a time-out to expire, before generating an interrupt to host system to process received packet(s). Receive Segment Coalescing (RSC) can be performed by the network interface device 500 in which portions of incoming packets are combined into segments of a packet. The network interface device 500 can then provide this coalesced packet to an application. A DMA engine 526 can copy a packet header, packet payload, and/or descriptor directly from host memory to the network interface or vice versa, instead of copying the packet to an intermediate buffer at the host and then using another copy operation from the intermediate buffer to the destination buffer. The memory 510 can be any type of volatile or non-volatile memory device and can store any queue or instructions used to program the network interface device 500. The transmit queue 507 can include data or references to data for transmission by network interface. The receive queue 508 can include data or references to data that was received by network interface from a network. The descriptor queues 520 can include descriptors that reference data or packets in transmit queue 507 or receive queue 508. The bus interface 512 can provide an interface with host device. For example, the bus interface 512 can be compatible with PCI Express, although other interconnection standards may be used.

As shown in FIG. 5B, a network interface device 550 can be configured as an implementation of the network interface device 500 to implement an InfiniBand HCA. The network interface device 550 includes network ports 552A-552B, memory 554A-554B, a PCIe interface 558 and an integrated circuit 556 that includes hardware, firmware, and/or software to implement, manage, and/or control HCA functionality. In one implementation, the integrated circuit includes a hardware transport engine 560, an RDMA engine 562, congestion control logic 563, virtual endpoint logic 564, offload engines 566, QoS logic 568, GSA/SMA logic 569, and a management interface. Different implementations of the network interface device 550 may include additional components or may exclude some components. A network interface device 550 configured as a TCA will include some implementation specific subset of the functionality of an HCA. The integrated circuit 556 includes programmable and fixed function hardware to implement the described functionality.

While the illustrated implementation of the network interface device 550 is shown as having a PCIe interface 558, other implementations can use other interfaces. For example, the network interface device 550 may use an Open Compute Project (OCP) mezzanine connector. Additionally, the PCIe interface 558 may also be configured with a multi-host solution that enables multiple compute or storage hosts to couple with the network interface device 550. The PCIe interface 558 may also support technology that enables direct PCIe access to multiple CPU sockets, which eliminates having network traffic traverse the inter-processor bus of a multi-socket server motherboard for a server that includes the network interface device 550.

The network interface device 550 implements endpoint elements of the InfiniBand architecture, which is based around queue pairs and RDMA. InfiniBand off-loads traffic control from software through the use of execution queues (e.g., work queues), which are initiated by a software client and managed in hardware. A communication endpoint includes a queue pair (QP) having a send queue and a receive queue. A QP is a memory-based abstraction where communication is achieved between memory-to-memory transfers between applications or between applications and devices. Communication to QPs occurs through virtual lanes of the network ports 552A-552B, which enable multiple independent data flows to share the same link, with separate buffering and flow control for the flows.

Communication occurs via channel I/O, in which a virtual channel directly connects two applications that exist in separate address spaces. The hardware transport engine 560 includes hardware logic to perform transport level operations via the QP for an endpoint. The RDMA engine 562 leverages the hardware transport engine 560 to perform RDMA operations between endpoints. The RDMA engine 562 implements RDMA operations in hardware and enables an application to read and write the memory of a remote system without OS kernel intervention or unnecessary data copies by allowing one endpoint of a communication channel to place information directly into the memory of another endpoint. The virtual endpoint logic 564 manages the operation of a virtual endpoint for channel I/O, which is a virtual instance of a QP that will be used by an application. The virtual endpoint logic 564 maps the QPs into the virtual address space of an application associated with a virtual endpoint.

Congestion control logic 563 performs operations to mitigate the occurrence of congestion on a channel. In various implementations, the congestion control logic 563 can perform flow control over a channel to limit congestion at the destination of a data transfer. The congestion control logic 563 can perform link level flow control to manage congestion at source congestion at virtual links of the network ports 552A-552B. In some implementations, the congestion control logic can take steps to limit congestion at intermediate points (e.g., IB switches) along a channel.

Offload engines 566 enable the offload of network tasks that may otherwise be performed in software to the network interface device 550. The offload engines 566 can support offload of operations including but not limited to offload of receive side scaling from a device driver or stateless network operations, for example, for TCP implementations over InfiniBand, such as TCP/UDP/IP stateless offload or VXLAN offload. The offload engines 566 can also implement operations of an interrupt coalesce circuit 522 of the network interface device 500 of FIG. 5A. The offload engines 566 can also be configured to support offload of NVME-oF or other storage acceleration operations from a CPU.

The QoS logic 568 can perform QoS operations, including QoS functionality that is inherent within the basic service delivery mechanism of InfiniBand. The QoS logic 568 can also implement enhanced InfiniBand QoS, such as fine grained end-to-end QoS. The QoS logic 568 can implement queuing services and management for prioritizing flows and guaranteeing service levels or bandwidth according to flow priority. For example, the QoS logic 568 can configure virtual lane arbitration for virtual lanes of the network ports 552A-552B according to flow priority. The QoS logic 568 can also operate in concert with the congestion control logic 563.

The GSA/SMA logic 569 implements general services agent (GSA) operations to manage the network interface device 550 and the InfiniBand fabric, as well as performing subnet management agent operations. The GSA operations include device-specific management tasks, such as querying device attributes, configuring device settings, and controlling device behavior. The GSA/SMA logic 569 can also implement SMA operations, including a subset of the operations performed by the SMA 476 of the InfiniBand switch 450 of FIG. 4C. For example, the GSA/SMA logic 569 can handle management requests from the subnet manager, including device reset requests, firmware update requests, or requests to modify configuration parameters.

The management interface 570 provides support for a hardware interface to perform out-of-band management of the network interface device 550, such as an interconnect to a board management controller (BMC) or a hardware debug interface.

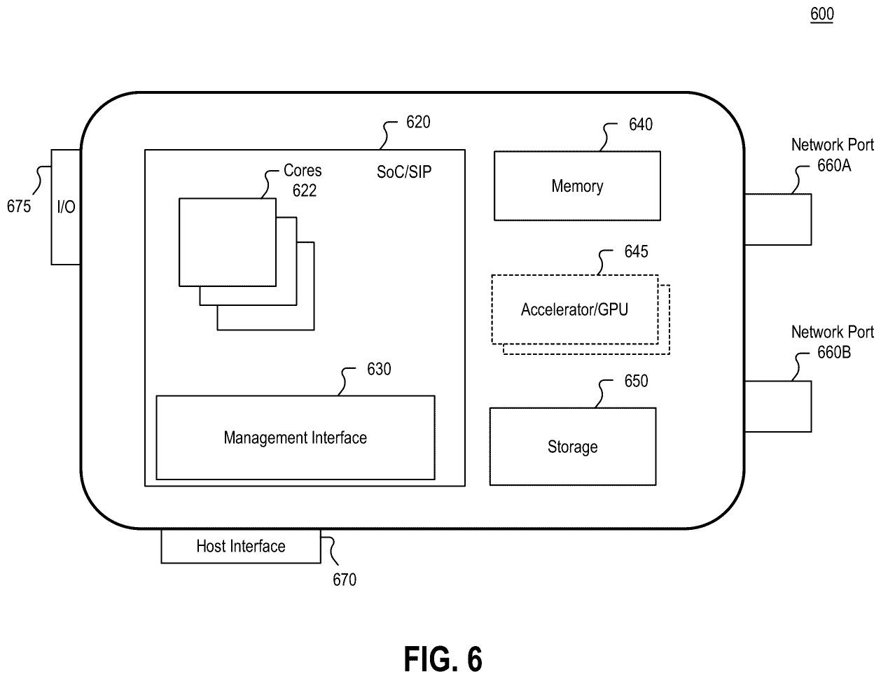

FIG. 6 is a block diagram illustrating a programmable network interface 600 and data processing unit. The programmable network interface 600 is a programmable network engine that can be used to accelerate network-based compute tasks within a distributed environment. The programmable network interface 600 can couple with a host system via host interface 670. The programmable network interface 600 can be used to accelerate network or storage operations for CPUs or GPUs of the host system. The host system can be, for example, a node of a distributed learning system used to perform distributed training, for example, as shown in FIG. 6. The host system can also be a data center node within a data center.

In one embodiment, access to remote storage containing model data can be accelerated by the programmable network interface 600. For example, the programmable network interface 600 can be configured to present remote storage devices as local storage devices to the host system. The programmable network interface 600 can also accelerate RDMA operations performed between GPUs of the host system with GPUs of remote systems. In one embodiment, the programmable network interface 600 can enable storage functionality such as, but not limited to NVME-oF. The programmable network interface 600 can also accelerate encryption, data integrity, compression, and other operations for remote storage on behalf of the host system, allowing remote storage to approach the latencies of storage devices that are directly attached to the host system.

The programmable network interface 600 can also perform resource allocation and management on behalf of the host system. Storage security operations can be offloaded to the programmable network interface 600 and performed in concert with the allocation and management of remote storage resources. Network-based operations to manage access to the remote storage that would otherwise by performed by a processor of the host system can instead be performed by the programmable network interface 600.

In one embodiment, network and/or data security operations can be offloaded from the host system to the programmable network interface 600. Data center security policies for a data center node can be handled by the programmable network interface 600 instead of the processors of the host system. For example, the programmable network interface 600 can detect and mitigate against an attempted network-based attack (e.g., DDoS) on the host system, preventing the attack from compromising the availability of the host system.

The programmable network interface 600 can include a system on a chip (SoC/SIP 620) that executes an operating system via multiple processor cores 622. The processor cores 622 can include general-purpose processor (e.g., CPU) cores. In one embodiment the processor cores 622 can also include one or more GPU cores. The SoC/SIP 620 can execute instructions stored in a memory device 640. A storage device 650 can store local operating system data. The storage device 650 and memory device 640 can also be used to cache remote data for the host system. Network ports 660A-660B enable a connection to a network or fabric and facilitate network access for the SoC/SIP 620 and, via the host interface 670, for the host system. In one configuration, a first network port 660A can connect to a first forwarding element, while a second network port 660B can connect to a second forwarding element. Alternatively, both network ports 660A-660B can be connected to a single forwarding element using a link aggregation protocol (LAG). The programmable network interface 600 can also include an I/O interface 675, such as a USB interface. The I/O interface 675 can be used to couple external devices to the programmable network interface 600 or as a debug interface. The programmable network interface 600 also includes a management interface 630 that enables software on the host device to manage and configure the programmable network interface 600 and/or SoC/SIP 620. In one embodiment the programmable network interface 600 may also include one or more accelerators or GPUs 645 to accept offload of parallel compute tasks from the SoC/SIP 620, host system, or remote systems coupled via the network ports 660A-660B. For example, the programmable network interface 600 can be configured with a graphics processor and participate in general-purpose or graphics compute operations in a datacenter environment.

One or more aspects may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the embodiments described herein.

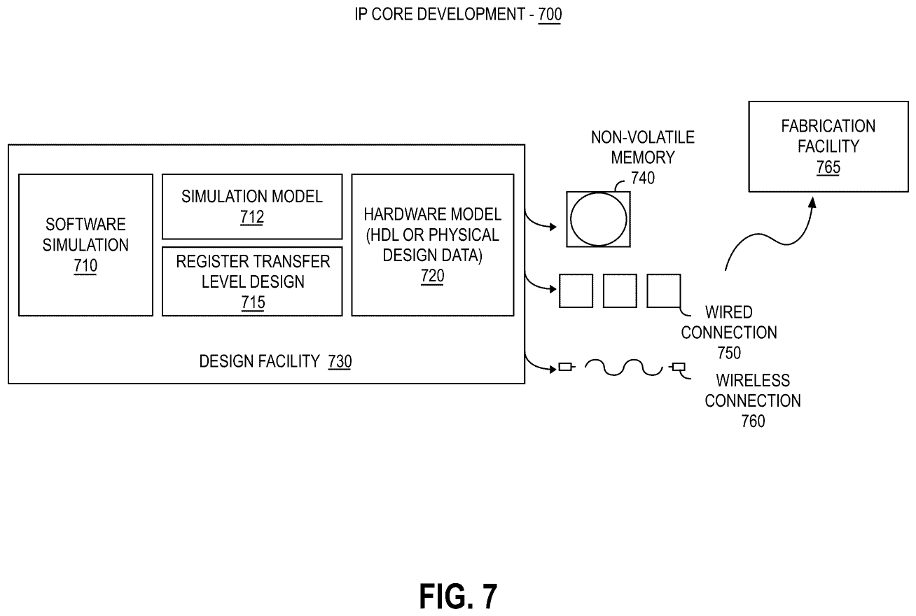

FIG. 7 is a block diagram illustrating an IP core development system 700. The IP core development system 700 may be used to manufacture an integrated circuit to perform operations of fabric and datacenter components described herein. The IP core development system 700 may be used to generate modular, re-usable designs that can be incorporated into a larger design or used to construct an entire integrated circuit (e.g., an SOC integrated circuit). A design facility 730 can generate a software simulation 710 of an IP core design in a high-level programming language (e.g., C/C++). The software simulation 710 can be used to design, test, and verify the behavior of the IP core using a simulation model 712. The simulation model 712 may include functional, behavioral, and/or timing simulations. A register transfer level design (RTL design 715) can then be created or synthesized from the simulation model 712. The RTL design 715 is an abstraction of the behavior of the integrated circuit that models the flow of digital signals between hardware registers, including the associated logic performed using the modeled digital signals. In addition to an RTL design 715, lower-level designs at the logic level or transistor level may also be created, designed, or synthesized. Thus, the particular details of the initial design and simulation may vary.

The RTL design 715 or equivalent may be further synthesized by the design facility into a hardware model 720, which may be in a hardware description language (HDL), or some other representation of physical design data. The HDL may be further simulated or tested to verify the IP core design. The IP core design can be stored for delivery to a fabrication facility 765 using non-volatile memory 740 (e.g., hard disk, flash memory, or any non-volatile storage medium). The fabrication facility 765 may be a 3^{rd} party fabrication facility. Alternatively, the IP core design may be transmitted (e.g., via the Internet) over a wired connection 750 or wireless connection 760. The fabrication facility 765 may then fabricate an integrated circuit that is based at least in part on the IP core design. The fabricated integrated circuit can be configured to perform operations in accordance with at least one embodiment described herein.

### Computer Vision Pipeline Management in Programmable Network Interface Device

In highly virtualized environments, significant amounts of server resources are expended processing tasks that are beyond user applications. Such processing tasks can include hypervisors, container engines, network and storage functions, security, and large amounts of network traffic. To address these various processing tasks, programmable network interface devices with accelerators and network connectivity have been introduced. These programmable network interface devices are referred to as infrastructure processing units (IPUs), data processing units (DPUs), advanced network interface devices, programmable packet processing devices, and so on.

The programmable network interface devices can accelerate and manage infrastructure functions using dedicated and programmable cores deployed in the devices. The programmable network interface devices can provide for infrastructure offload and an extra layer of security by serving as a control point of the host for running infrastructure applications. By using programmable network interface devices, the overhead associated with running infrastructure tasks can be offloaded from a server device.

In implementations herein, the programmable network interface devices may be referred to generally as a programmable network interface device (PNID), a network interface device, an advanced network interface device, an IPU, or a DPU, or a programable packet processing device, for example. For the discussion herein, the programmable network interface device will be referred to in abbreviated form as PNID.

PNIDs frequently are involved in a variety of different data flow pipelines. One example data pipeline having a set of tasks that generate data that flows through a PNID is a computer vision (CV) pipeline. CV pipelines can refer to a sequence of processes that transforms raw media data into visual and/or interpreted information about the media data. CV pipelines often implement an AI model for the analysis and interpretation of the media data. An example sequence of processes for a CV pipeline can include media (e.g., image, video, etc.) acquisition, preprocessing, media segmentation, feature extraction, object detection, object recognition and classification, post-processing, and visualization and interpretation.

CV pipelines are often utilized in the field of video analytics, for example. The performance and scalability of CPU processing in video analytics can be constrained by several factors, with the decoding of video streams being one of those constraints. Techniques to process a high volume of streams per server are beneficial and sought after by consumers. Portions of the CV pipeline, such as the portions applying media processing, may be configured to improve scalability. Media processing can refer to herein encoding/decoding, resizing/scaling, normalization, noise reduction, data augmentation (rotating, flipping, cropping), quality adjustments, color adjustment, and so on. For example, the decoding process can provide an opportunity for optimization, as decoding currently limits scalability. Additionally, as another example, encoding to retransmit video adds a further layer of computational expense. A scalable solution that transfers the media processing operation workload from server CPUs to programmable network interface devices (such as IPUs) would improve the performance and scalability of CPU processing video analytics.

Conventional approaches to transferring the media processing workload away from the CPU or host device are implemented with increased network latency and low scaling. For example, one conventional approach includes a host with a NIC (or other interface device) that ingests media (e.g., video, images, etc.) and passes the media on to the host so that the host can decode and process the media. This conventional approach increases latency as the incoming media is not pre-processed in the NIC. If a programmable network interface device (e.g., PNID) is used, then decoding could also be performed with software, but that also can make the process inefficient.

Implementations herein address the above-noted technical problems by providing for CV pipeline management in programmable network interface devices. The CV pipeline management in programmable network interface devices discussed herein provides for a decomposed CV pipeline using a programmable network interface device on which to offload media processing capabilities of the CV pipeline. This is a scalable mechanism to accelerate video processing through programmable network interface devices. As previously noted, NICs can enable the inflow of traffic to servers, but they are just a passthrough mechanism. With programmable network interface devices, such as IPUs and DPUs, which are used to offload networking workload processing, and aligned with what a NIC card provides, it is possible to perform media processing, such as decode/encode of incoming media (e.g., video, images, etc.) traffic in the programmable network interface device. The techniques described herein can offload a large amount of the initial media processing, and provides ready to use (raw) video to the CV pipeline workloads running in server (e.g., host device) through CPU processing. Implementations herein may be extended to GPUs and other accelerators as well. The mechanism can be seen as a coordinated multipipeline processing running in different components.

In implementations herein, once the media processing portion (such as decoding/encoding) of the CV pipeline occurs in the programmable network interface device, the raw data (e.g., raw video, raw image, etc.) is sent to the host through a memory access protocol, such as RDMA, for fast access. Implementations herein introduce media processing hardware circuitry, such as an encoder/decoder hardware circuitry, in the programmable network interface device. Implementations herein further provide the decomposable CV pipeline by ingesting data directly from the programmable network interface device and providing ready-to-process raw frames to AI-processors/accelerators on the host device. This reduces latency on data transmission, allowing better host resource utilization, while also enabling the execution of parts of the CV pipeline in different devices depending on resource availability.

Implementations herein provide a technical advantage of a scalable solution that transfers the media processing operation workload from server CPUs to programmable network interface devices (such as IPUs). This improves the performance and scalability of CPU processing video analytics of a CV pipeline. Implementations herein can increase the number of streams that can be processed, thereby boosting the overall efficiency of the computing environment (e.g., data center, etc.). By offloading these initial video processing tasks to specialized hardware, the solution should also reduce latency and liberate CPU resources for more advanced CV operations.

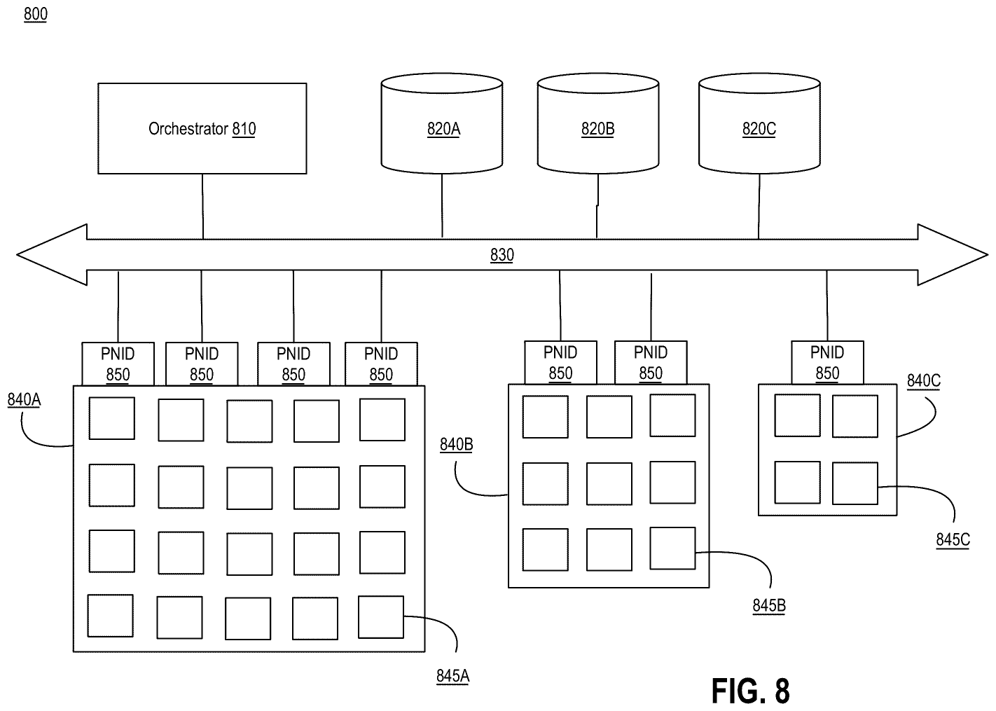

Further details on the implementations of CV pipeline management in programmable network interface devices are described below with respect to FIGS. 8-12.

FIG. 8 is a block diagram illustrating an example computing environment 800 for providing for CV pipeline management in programmable network interface devices, according to implementations herein. In one implementation, the computing environment 800 that may include various clusters (e.g., 840A-C) of processing units 845A-845C (e.g., GPUs, Tensor Flow processors, other types of accelerators, etc.). A cluster 840 may also include one or more PNIDs 850 to facilitate communication between the processing units 845 and network 830. Network 830 may further be coupled to various storage devices 820A-C and orchestrator 810.

The elements of FIG. 8 having the same or similar names as the elements of any other figure herein describe the same elements as in the other figures, can operate or function in a manner similar to that, can comprise the same components, and can be linked to other entities, as those described elsewhere herein, but are not limited to such. Therefore, the discussion of any features in combination with a graphics processor herein also discloses a corresponding combination with the example computing environment 800, but is not limited to such.

In various embodiments, components of computing environment 800 (including requesting, target, and/or consuming devices) may be coupled together through one or more networks (e.g., network) comprising any number of intervening network nodes, such as routers, switches, or other computing devices. The network, the requesting device, and/or the target device may be part of any suitable network topography, such as a data center network, a wide area network, a local area network, an edge network, or an enterprise network.

The storage command may be communicated from the requesting device to the target device and/or data read responsive to a storage command may be communicated from the target device to the consuming device over any suitable communication protocol (or multiple protocols), such as peripheral component interconnect (PCI), PCI Express (PCie), CXL, Universal Serial Bus (USB), Serial Attached SCSI (SAS), Serial ATA (SATA), InfiniBand, Fibre Channel (FC), IEEE 802.3, IEEE 802.11, Ultra Ethernet, or other current or future signaling protocol. The storage command may include, but is not limited to, commands to write data, read data, and/or erase data, for example. In particular embodiments, the storage commands conform with a logical device interface specification (also referred to herein as a network communication protocol) such as Non-Volatile Memory Express (NVMe) or Advanced Host Controller Interface (AHCI), for example.

A computing platform, such as computing environment 800, may include one or more requesting devices, consuming devices, and/or target devices. Such devices may comprise one or more processing units (e.g., processing units 845) to generate a storage command, decode and process a storage command, and/or consume (e.g., process) data requested by a storage command. As used herein, the terms “processor unit”, “processing unit”, “processor”, or “processing element”, may refer to any device or portion of a device that processes electronic data from registers and/or memory to transform that electronic data into other electronic data that may be stored in registers and/or memory. A processing unit may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), edge processing units (EPUs), vector processing units, software defined processing units, video processing units, data processor units (DPUs), memory processing units, storage processing units, accelerators (e.g., graphics accelerator, compression accelerator, artificial intelligence accelerator, networking accelerator), controller cryptoprocessors (specialized processors that execute cryptographic algorithms within hardware), server processors, I/O controllers, NICs (e.g., SmartNICs), infrastructure processing units (IPUs), microcode engines, memory controllers (e.g., cache controllers, host memory controllers, DRAM controllers, SSD controllers, hard disk drive (HDD) controllers, nonvolatile memory controllers, etc.), or any other suitable type of processor units. As such, a processor unit may be referred to as an XPU.

Components of computing environment 800 may have any suitable characteristics of similar components of those described with respect to FIGS. 5 and 6. For example, computing environment 800 may be, e.g., an Ethernet, Ultra Ethernet, CXL, a network using a proprietary network protocol, or other suitable network, utilizing the network interface device 500 of FIG. 5 herein or programmable network interface 600 of FIG. 6.

In some embodiments, computing environment 800 may be a data center or other similar environment, where any combination of the components may be placed together in a rack or shared in a data center pod. In various embodiments, computing environment 800 may represent a telecom environment, in which any combination of the components may be enclosed together in curb/street furniture or an enterprise wiring closet.

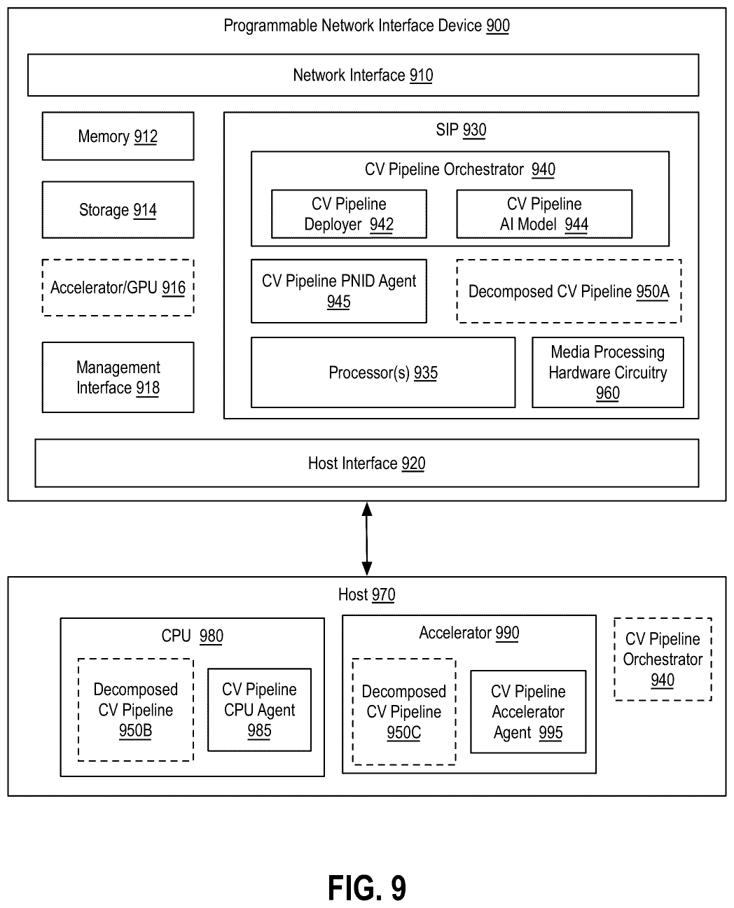

In some embodiments, orchestrator 810 may function as a requesting device and send storage commands as described herein to storage devices 820A-C functioning as target devices. Some of these commands may read data that is then supplied to processing units 845 that are functioning as consuming devices. In some embodiments, a processing unit 845 or an PNID 850 may function as the requesting device. Thus, a processing unit 845 could be both a requesting device and the consuming device. In one implementation, PNID 850 may be the same as network interface device 500 of FIG. 5 herein or programmable network interface 600 and data processing unit of FIG. 6 herein, and can be referred to as an IPU or a DPU, for example. As previously discussed, the PNID 850 in implementations herein is configured to provide for CV pipeline management in programmable network interface devices, a further discussed with respect to FIGS. 9-12 below.

FIG. 9 is a block diagram of an example PNID 900 for providing CV pipeline management in programmable network interface devices, in accordance with implementations herein. In one implementation, PNID 900 may be the same as PNID 850 described with respect to FIG. 8. In some implementations, PNID 900 may be the same as network interface device 500 of FIG. 5 herein and/or programmable network interface 600 and data processing unit of FIG. 6 herein, and may be referred to as an IPU or a DPU in some examples. In one implementation, the PNID 900 includes media processing hardware circuitry 960 to support the media processing tasks of a decomposed CV pipeline 950A deployed on the PNID 900. In one implementation, the media processing hardware circuitry 960 may be hosted by the SIP 930 of PNID 900. In one example, the media processing hardware circuitry 960 may include hardware circuitry specialized for encoding and/or decoding a specific codec, such as the h264 codec.

In one configuration, the PNID 900 can include a network interface 910, memory 912, storage 914, an accelerator/GPU 916, a management interface 918, and a host interface 920. The PNID 900 can also include an SIP 930, which includes processors 935 to implement smart network interface device functionality. In some implementations, processors 935 may include accelerators for various accelerated functionality, such as NVMe-oF or RDMA. The specific makeup of the PNID 900 depends on the protocol implemented via the PNID 900.

In various configurations, the PNID 900 is configurable to interface with networks including but not limited to InfiniBand, Ethernet, or NVLink. The SIP 930 can include processors 935 that may be any a combination of a CPU processor, graphics processing unit (GPU), field programmable gate array (FPGA), application specific integrated circuit (ASIC), or other programmable hardware device that allow programming of ANID P00. For example, a smart network interface can provide packet processing capabilities in the network interface using processors 935. Configuration of operation of processors 935, including programmable data plane processors, can be programmed using Programming Protocol-independent Packet Processors (P4), C, Python, Broadcom Network Programming Language (NPL), x86, or ARM compatible executable binaries or other executable binaries.

In some implementations, PNID 900 may be communicably coupled (e.g., over a network) to a host device, such as host 970. In one implementation, the host 970 may be the same as one of processing units 845 described with respect to FIG. 8. The host 970 may include one or more CPU(s) 980 and/or accelerator(s) 990 to perform various processing tasks.

As previously discussed, PNIDs, including PNID 900, often process the data flows of CV pipelines. CV pipelines can refer to a sequence of processes that transforms raw media data into visual and/or interpreted information about the media data. CV pipelines often implement an AI model for the analysis and interpretation of the media data, and are utilized in the field of video analytics, for example. As discussed herein, portions of the CV pipeline, such as the portions applying media processing, may be decomposed to improve scalability.

In implementations herein, the example PNID 900 can provide CV pipeline management, including implementing a decomposed CV pipeline in the PNID 900, as well as a host device (host 970) communicably coupled to the PNID 900. In one implementation, the media processing capabilities of the CV pipeline are offloaded to the PNID 900.

With a PNID 900, such as an IPU or a DPU, which is used to offload networking workload processing, it is possible to perform media processing, such as decode/encode of incoming media (e.g., video, images, etc.) traffic in the PNID 900. The techniques described herein can offload a large amount of the initial media processing, and provide ready to use (raw) video to the CV pipeline workloads running in the host 970 through CPU 980 or accelerator 990 processing. Implementations herein may be extended to GPUs and other accelerators as well. Implementations herein can be seen as a coordinated multipipeline processing running in different components.

In one implementation, the SIP 930 of the PNID 900 can implement a CV pipeline orchestrator 940 to enable the CV pipeline management techniques described herein. Although the CV pipeline orchestrator 940 is illustrated and discussed as part of the SIP 930 of PNID 900, implementations herein may also deploy the CV pipeline orchestrator 940 in the host 970 (As shown by the CV pipeline orchestrator 940 in dashed lines in host 970) and/or in other third party system devices (not shown).

The CV pipeline orchestrator 940 can cause a CV pipeline to be divided into different portions that are deployed on more than one device. For example, the CV pipeline orchestrator 940 can cause a CV pipeline to be divided into a decomposed CV pipeline 950A-950C portions that are deployed on the PNID 900 and the host 970. As illustrated in FIG. 9, CV pipeline orchestrator 940 may determine a first portion of CV pipeline that is deployed on SIP 930 of PNID as decomposed CV pipeline 950A, a second portion of CV pipeline that is deployed on CPU 980 of host 970 as decomposed CV pipeline 950C, and/or a third portion of CV pipeline that is deployed on accelerator 990 of host 970 as decomposed CV pipeline 950C. In some implementations, host 970 may deploy just one portion of the CV pipeline, either decomposed CV pipeline 950B or decomposed CV pipeline 950C.

In some implementations, the CV pipeline orchestrator 940 may operate in conjunction with CV pipeline agents 975, 985, 995 deployed on the target components. For example, PNID 900 runs a CV pipeline PNID agent 945, CPU 980 of host 970 runs a CV pipeline CPU agent 985, and accelerator 990 or host 970 runs a CV pipeline accelerator agent 995. In implementations herein, the CV pipeline orchestrator 940 can communicate with the CV pipeline agents 975, 985, 995 to instruct the agents to cause the determined portions of the decomposed CV pipeline 950A-950C to be deployed on the target components.

In one implementation, the CV pipeline orchestrator may include a CV pipeline deployer 942 and a CV pipeline AI model 944 that are utilized to determine where and how the decomposed CV pipeline 950A-950C may be deployed. To do this, the CV pipeline deployer 942 may define the CV pipeline by decomposable parts, which then are intelligently grouped and deployed (e.g., continuously and dynamically adapted). For the decomposable parts of the CV pipeline, the CV pipeline orchestrator 940 may store metrics that are used to understand resource consumption. Such metrics may include usage percentage and type of device, for example. The CV pipeline deployer 942 may interface with the CV pipeline AI model 944 to query for a prediction on future resource utilization of candidate components for decomposed CV pipeline deployment. The CV pipeline AI model 944 may execute an AI model that predicts future resource utilization via time series forecasting, for example. The CV pipeline AI model 944 can utilize data collected from the various candidate components (e.g., CPU 980, accelerator 990, PNID 900, etc.) to train the AI model.

In some implementations, the CV pipeline AI model 944 may use a combination of time series forecasting and classification for the future resource utilization prediction. For the time series forecasting, the CV pipeline AI model 944 may implement a Long Short-Term Memory network (LTSM). However, other types of models can be utilized, such as autoregressive integrated moving average (ARIMA). For the classification portion (e.g., to identify how to decompose the CV pipeline into particular portions), a random forest may be utilized. Implementations herein may also implement other types of classification models for the classification portion.

Once training is completed for the CV pipeline AI model 944, the CV pipeline AI model 944 can be deployed on the CV pipeline orchestrator 940 as CV pipeline AI model 944. In some implementations, the CV pipeline AI model 944 can be executed so that it can be continuously queried to decide on how to deploy the parts of the CV pipeline at a given time. In one implementation, decisions can be for CV pipeline decomposed deployment by the CV pipeline deployer 942 by evaluating the full pipeline deployment plan provided by the classification (considering all parts of the pipeline to ensure all components can be used at a given time).

Once the determination of how and where to deploy the decomposed CV pipeline is made, the CV pipeline deployer 942 can transmit instructions to the corresponding CV pipeline agents 975, 985, 995 of the components where the portions of the decomposed CV pipeline 950A-950C are to be deployed. The instructions enables the CV pipeline agents 975, 985, 995 to initiate the decomposed CV pipeline 950A-950C portions at the respective components (e.g., PNID 900, CPU 980, accelerator 990, etc.).

The CV pipeline orchestrator 940 can also communicate with the CV pipeline agents 975, 985, 995 to inform them of identifying information that enables the portions of the decomposed CV pipeline 950A-950C to be communicably coupled. The identifying information may include the addresses for RDMA or network addresses of the components where the decomposed CV pipeline 950A-950C is deployed. By providing the identifying information to the CV pipeline agents 975, 985, 995, the CV pipeline orchestrator 940 enables the multiple portions of the decomposed CV pipeline 950A-950C to be connected.

In some implementations herein, the CV pipeline orchestrator 940 utilizes the PNID 900 to host at least a portion of the decomposed CV pipeline 950A. The CV pipeline orchestrator 940 may identify resources of the PNID 900 to host media processing portions of the CV pipeline. The media processing portions may refer to stages of the CV pipeline that perform media processing tasks. The media processing tasks may refer to encoding and/or decoding, scaling, resizing, normalization, noise reduction, data augmentation (rotating, flipping, cropping), quality adjustments, color adjustment, and so on. In one implementation, the PNID 900 includes media processing hardware circuitry 960 to support the media processing tasks of the decomposed CV pipeline 950A deployed on the PNID 900. In one implementation, the media processing hardware circuitry 960 may be hosted by the SIP 930 of PNID 900. In one example, the media processing hardware circuitry 960 may include hardware circuitry specialized for encoding and/or decoding a specific codec, such as the h264 codec.

In some implementations, based on priorities given, the PNID portion (e.g., 950A) of the CV pipeline may reduce the resolution/scale of the video adaptively based on network bandwidths or other constraints, or other programmable AI operations on media (e.g., video).

In implementations herein, by offloading the decoding and/or encoding processing tasks, for example, to the PNID 900, the PNID 900 is able to provide raw data (e.g., ready to be processed) for consumption by an AI portion of the decomposed CV pipeline 950B, 950C that may be running on the host 970 for internal server consumption. This reduces latency on data transmission, allowing better host resource utilization, while also enabling the execution of parts of the CV pipeline in different devices depending on resource availability.

The following is one example use case of implementing a decomposed CV pipeline that is orchestrated by a PNID, such as PNID 900. The following example may represent a CV pipeline for an end user that is working on video processing. The CV pipeline may utilize a h.264 code, with a video resolution of 1080p, and an AI model for person detection or inference. In the example, the CV pipeline can utilize Gstreamer, an open-source multimedia framework to create media application (streaming, media playback, editing, etc.). To provide the decomposed CV pipeline, the CV pipeline orchestrator 940 may receive a request to implement a Gstreamer pipeline as follows:
gst-launch-1.0 rtspsrc location=rtsp://rtsp_stream !rtph264depay !h264parse !decoder !videoconvert !videoscale !gvadetect model=model_file [device=accelerator?]!fakesink

To implement the decomposed CV pipeline, the CV pipeline orchestrator 940 may utilize the CV pipeline deployer 942 and CV pipeline AI model 944 to determine how to decompose the CV pipeline into separate portions and which components to host the decomposed CV pipeline. In the example, the CV pipeline orchestrator 940 may identify a first portion of the CV pipeline to deploy on the PNID 900 as decomposed CV pipeline 950A and a second portion of the CV pipeline to deploy on host 970 (CPU 980) as decomposed CV pipeline 950B.

The first portion (decomposed CV pipeline 950A) connects to the external video endpoint and runs pre-processing actions such as decode or video scale. The first portion can provide ready-to-be AI-processed frames (e.g., raw frames) used for internal server consumption at the CPU 980 of host 970 using the second portion (decomposed CV pipeline 950B) of the CV pipeline.

The first portion of the pipeline may be deployed at the PNID 900, for example, using the following Gstreamer example:
gst-launch-1.0 rtspsrc location=rtsp://rtsp_stream !rtph264depay !h264parse ![PNIDdecoder]!videoconvert !videoscale ![new_sink];
Where:
location=RTSP source;
rtph264depay=checks that the video stream is properly formatted and contains metadata;
PNIDdecoder=Decode offload to IPU, Raw frame sent to Host memory thru RDMA (or any other compatible memory access protocol);
videoscale/videoconvert=Adapts the frames for the AI model of the CV pipeline;
new_sink=in charge of pushing the raw frames to the shared location with the host 970 (e.g., using RDMA).

The second portion of the CV pipeline may be deployed at the host 970 (e.g., at CPU 980 or accelerator 990), for example, and can obtain the raw data from the new source (e.g., “new sink”) provided by the previous first portion of the CV pipeline. The second portion may be deployed using the following Gstreamer example:
gst-launch-1.0 [load_stream]!gvadetect model=model_file [device=accelerator?]!fakesink;
Where:
gvadetect=Runs AI model of the CV pipeline (e.g., person detection model);
fakesink=Placeholder to handle the metadata output of the AI model.

As previously discussed, the PNID 900 can provide discovery and/or enablement for CV pipeline management, such as the CV pipeline offload described herein. In some implementations, the PNID 900 can provide an API though which the CV pipeline management and offload as described herein can be implemented. In some implementations, the API can query whether a computing system supports the PNID-based CV pipeline management and offload capabilities. For example, the API can query whether the CV pipeline decomposing and offload functionality as described herein is provided by the PNID 900. In some implementations, the API can enable or disable such a capability. For example, the API may be configured to enable and/or disable the CV pipeline management including CV pipeline decomposing and offload in the PNID 900.

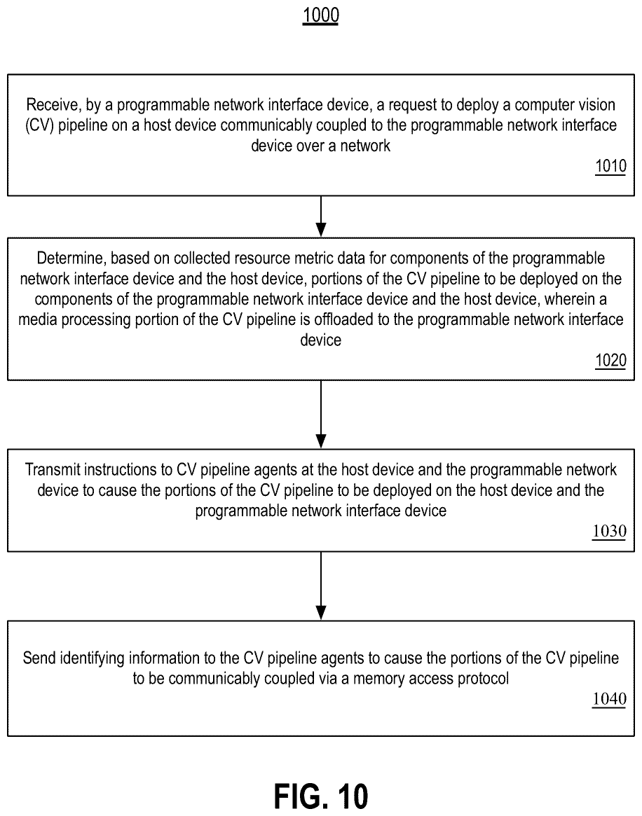

FIG. 10 is a flow diagram illustrating an embodiment of a method 1000 for providing CV pipeline management in a programmable network interface device. Method 1000 may be performed by processing logic that may comprise hardware (e.g., circuitry, dedicated logic, programmable logic, etc.), software (such as instructions run on a processing device), or a combination thereof. The process of method 1000 is illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-9 may not be repeated or discussed hereafter. In one implementation, a PNID, such as PNID 850 of FIG. 8 and/or PNID 900 of FIG. 9, may perform method 1000.

Method 1000 begins at processing block 1010 where the PNID may receive a request to deploy a computer vision (CV) pipeline on a host device communicably coupled to the PNID over a network. Then, at block 1020, the PNID may determine, based on collected resource metric data for components of the PNID and the host device, portions of the CV pipeline to be deployed on the components of the programmable network interface device and the host device. In one implementation, a media processing portion of the CV pipeline is offloaded to the programmable network interface device.

Subsequently, at block 1030, the PNID may transmit instructions to CV pipeline agents at the host device and the programmable network device to cause the portions of the CV pipeline to be deployed on the host device and the programmable network interface device. Lastly, at block 1040, the PNID may send identifying information to the CV pipeline agents to cause the portions of the CV pipeline to be communicably coupled via a memory access protocol.

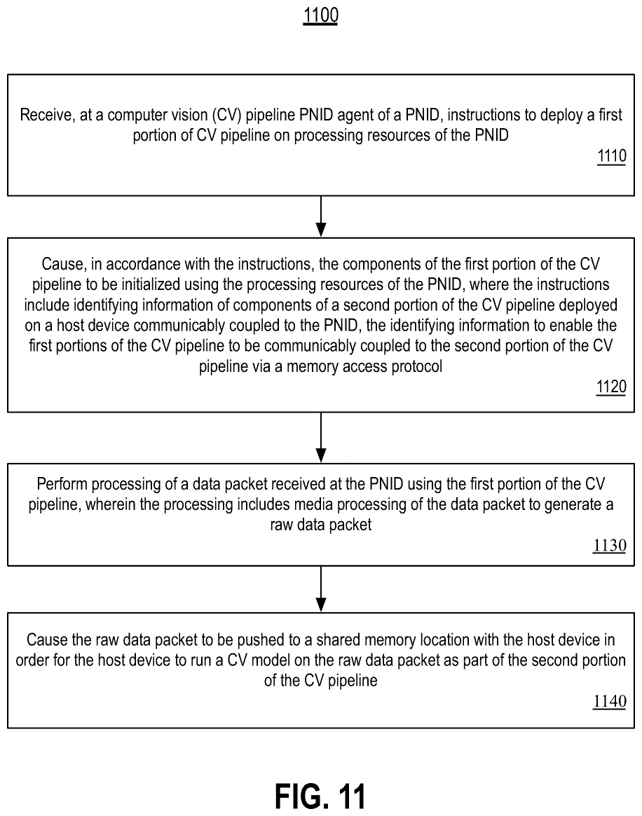

FIG. 11 is a flow diagram illustrating an embodiment of a method 1100 for providing a media processing portion of a CV pipeline in a PNID. Method 1100 may be performed by processing logic that may comprise hardware (e.g., circuitry, dedicated logic, programmable logic, etc.), software (such as instructions run on a processing device), or a combination thereof. The process of method 1100 is illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-10 may not be repeated or discussed hereafter. In one implementation a PNID, such as PNID 850 of FIG. 8 and/or PNID 900 of FIG. 9, may perform method 1100.

Method 1100 begins at processing block 1110 where the PNID may receive, at a computer vision (CV) pipeline PNID agent of a PNID, instructions to deploy a first portion of CV pipeline on processing resources of the PNID. Then, at block 1120, the PNID may cause, in accordance with the instructions, the components of the first portion of the CV pipeline to be initialized using the processing resources of the PNID. In one implementation, the instructions can include identifying information of components of a second portion of the CV pipeline deployed on a host device communicably coupled to the PNID, where the identifying information to enable the first portions of the CV pipeline to be communicably coupled to the second portion of the CV pipeline via a memory access protocol.

Subsequently, at block 1130, the PNID may perform processing of a data packet received at the PNID using the first portion of the CV pipeline. In one implementation, the processing includes media processing of the data packet to generate a raw data packet. Lastly, at block 1140, the PNID may cause the raw data packet to be pushed to a shared memory location with the host device in order for the host device to run a CV model on the raw data packet as part of the second portion of the CV pipeline.

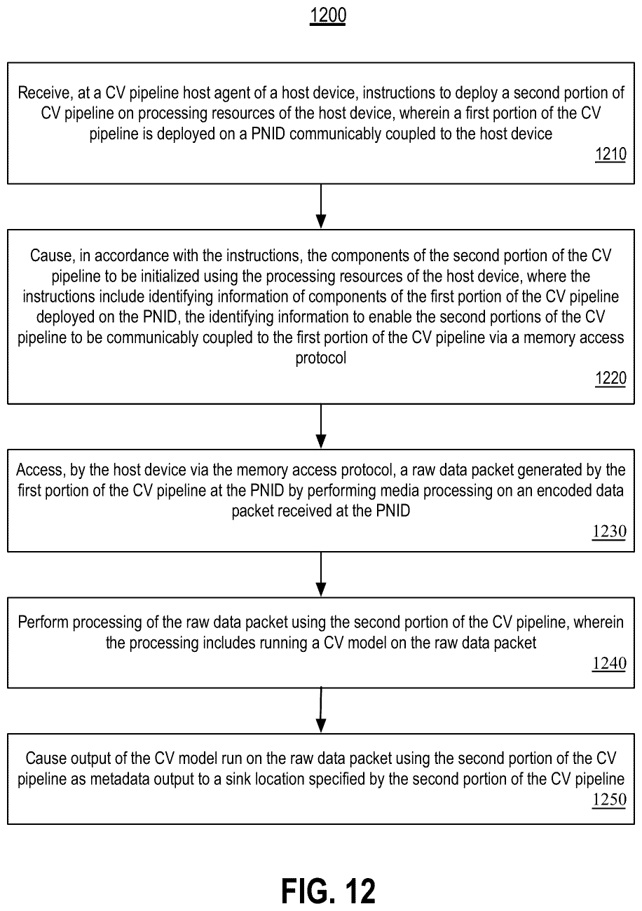

FIG. 12 is a flow diagram illustrating an embodiment of a method 1200 for providing a decomposed portion of CV pipeline in a host device. Method 1200 may be performed by processing logic that may comprise hardware (e.g., circuitry, dedicated logic, programmable logic, etc.), software (such as instructions run on a processing device), or a combination thereof. The process of method 1200 is illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-11 may not be repeated or discussed hereafter. In one implementation, a host device, such as host 970 of FIG. 9, may perform method 1200.

Method 1200 begins at processing block 1210 where the host device may receive, at a CV pipeline host agent of the host device, instructions to deploy a second portion of CV pipeline on processing resources of the host device. In one implementation, a first portion of the CV pipeline is deployed on a PNID communicably coupled to the host device. Then, at block 1220, the host device may cause, in accordance with the instructions, the components of the second portion of the CV pipeline to be initialized using the processing resources of the host device. In one implementation, the instructions can include identifying information of components of the first portion of the CV pipeline deployed on the PNID, where the identifying information to enable the second portions of the CV pipeline to be communicably coupled to the first portion of the CV pipeline via a memory access protocol.

Subsequently, at block 1230, the host device may access, via the memory access protocol, a raw data packet generated by the first portion of the CV pipeline at the PNID by performing media processing on an encoded data packet received at the PNID. At block 1240, the host device may perform processing of the raw data packet using the second portion of the CV pipeline, wherein the processing includes running a CV model on the raw data packet. Lastly, at block 1250, the host device may cause output of the CV model run on the raw data packet using the second portion of the CV pipeline as metadata output to a sink location specified by the second portion of the CV pipeline.

The following examples pertain to further embodiments. Example 1 is an apparatus to facilitate CV pipeline management in a programmable network interface device. The apparatus of Example 1 includes a host interface; a network interface; and a programmable circuitry communicably coupled to the host interface and the network interface, the programmable circuitry comprising one or more processors to implement network interface functionality and to: determine portions of a set of computer vision (CV) processes to be deployed on the programmable circuitry and a host device, wherein the host device to be communicably coupled to the programmable network interface device; and access instructions to cause the portions of the set of the CV processes to be deployed on the host device and the programmable network interface device; wherein a media processing portion of the set of the CV processes is to be deployed to the programmable circuitry, and wherein the programmable circuitry is to utilize media processing hardware circuitry hosted by the apparatus to perform the media processing portion.

In Example 2, the subject matter of Example 1 can optionally include wherein the portions of the set of the CV processes to be deployed on the programmable circuitry and the host device are determined based on resource metric data collected for programmable circuitry and the host device. In Example 3, the subject matter of any one of Examples 1-2 can optionally include wherein the programmable circuitry is further to indicate identifying information to cause the portions of the set of the CV processes to be communicably coupled via a memory access protocol. In Example 4, the subject matter of any one of Examples 1-3 can optionally include wherein the media processing portion comprises one or more of decoding of data packets, encoding of the data packets, resizing of the data packets, quality modification of the data packets, or color conversion of the data packets.

In Example 5, the subject matter of any one of Examples 1-4 can optionally include wherein a first portion of the portions of the set of the CV processes is deployed on the programmable circuitry and a second portion of the portions of the set of the CV processes is deployed on the host device, and wherein the second portion that is deployed on the host device is to run an artificial intelligence (AI) model of the set of CV processes on data packets received from the first portion deployed on the programmable circuitry. In Example 6, the subject matter of any one of Examples 1-5 can optionally include wherein the data packets received by the second portion comprise decoded data packets that are decoded by the first portion at the programmable circuitry.

In Example 7, the subject matter of any one of Examples 1-6 can optionally include wherein the second portion of the set of the CV processes is to store a metadata output of the AI model in a sink designated to consume the metadata output of the set of the CV processes. In Example 8, the subject matter of any one of Examples 1-7 can optionally include wherein the identifying information comprises at least one of addresses for remote direct memory access (RDMA) or network addresses of the components, and wherein the memory access protocol comprises at least one of an RDMA protocol, a non-volatile memory express (NVMe) protocol, or a NVME over Fabrics (NVMe-oF) protocol.

In Example 9, the subject matter of any one of Examples 1-8 can optionally include wherein the host device comprises one or more of a central processing unit (CPU), a graphics processing unit (GPU), or hardware accelerator device to execution the portions of the set of the CV processes deployed on the host device. In Example 10, the subject matter of any one of Examples 1-9 can optionally include wherein the one or more processors of the programmable circuitry are to implement a CV orchestrator to cause the programmable circuitry to determine the portions and to access the instructions.

Example 11 is a method for facilitating CV pipeline management in a programmable network interface device. The method of Example 11 can include determining, by one or more processors of programmable circuitry of a programmable network interface device comprising a host interface and a network interface, determine portions of a set of computer vision (CV) processes to be deployed on the programmable circuitry and a host device, wherein the host device to be communicably coupled to the programmable network interface device; and accessing instructions to cause the portions of the set of the CV processes to be deployed on the host device and the programmable network interface device; wherein a media processing portion of the set of the CV processes is to be deployed to the programmable circuitry, and wherein the programmable circuitry is to utilize media processing hardware circuitry hosted by the apparatus to perform the media processing portion.

In Example 12, the subject matter of Example 11 can optionally include wherein the portions of the set of the CV processes to be deployed on the programmable circuitry and the host device are determined based on resource metric data collected for programmable circuitry and the host device. In Example 13, the subject matter of Examples 11-12 can optionally include further comprising indicating identifying information to cause the portions of the CV pipeline to be communicably coupled via a memory access protocol.

In Example 14, the subject matter of Examples 11-13 can optionally include wherein the media processing portion comprises one or more of decoding of data packets, encoding of the data packets, resizing of the data packets, quality modification of the data packets, or color conversion of the data packets. In Example 15, the subject matter of Examples 11-14 can optionally include wherein a first portion of the portions of the set of the CV processes is deployed on the programmable circuitry and a second portion of the portions of the set of the CV processes is deployed on the host device, and wherein the second portion that is deployed on the host device is to run an artificial intelligence (AI) model of the set of CV processes on data packets received from the first portion deployed on the programmable circuitry.

In Example 16, the subject matter of Examples 11-15 can optionally include wherein the data packets received by the second portion comprise decoded data packets that are decoded by the first portion at the programmable circuitry, and wherein the second portion of the set of the CV processes is to store a metadata output of the AI model in a sink designated to consume the metadata output of the set of the CV processes.

Example 17 is a non-transitory computer-readable storage medium for facilitating CV pipeline management in a programmable network interface device. The non-transitory computer-readable storage medium of Example 17 having instructions stored thereon, which when executed by one or more processors, cause the one or more processors to perform operations that are to: determine, by the one or more processors of programmable circuitry of a programmable network interface device comprising a host interface and a network interface, determine portions of a set of computer vision (CV) processes to be deployed on the programmable circuitry and a host device, wherein the host device to be communicably coupled to the programmable network interface device; and access instructions to cause the portions of the set of the CV processes to be deployed on the host device and the programmable network interface device; wherein a media processing portion of the set of the CV processes is to be deployed to the programmable circuitry, and wherein the programmable circuitry is to utilize media processing hardware circuitry hosted by the apparatus to perform the media processing portion.

In Example 18, the subject matter of Example 17 can optionally include wherein the portions of the set of the CV processes to be deployed on the programmable circuitry and the host device are determined based on resource metric data collected for programmable circuitry and the host device. In Example 19, the subject matter of Examples 17-18 can optionally include wherein the media processing portion comprises one or more of decoding of data packets, encoding of the data packets, resizing of the data packets, quality modification of the data packets, or color conversion of the data packets.

In Example 20, the subject matter of Examples 17-19 can optionally include wherein a first portion of the portions of the set of the CV processes is deployed on the programmable circuitry and a second portion of the portions of the set of the CV processes is deployed on the host device, and wherein the second portion that is deployed on the host device is to run an artificial intelligence (AI) model of the set of CV processes on data packets received from the first portion deployed on the programmable circuitry.

Example 21 is a system for CV pipeline management in a programmable network interface device. The system of Example 21 can optionally include a cluster of processing units; and a programmable network interface device communicably coupled to the cluster of processing units and comprising a host interface; a network interface; and a programmable circuitry communicably coupled to the host interface and the network interface, the programmable circuitry comprising one or more processors to implement network interface functionality and to: determine portions of a set of computer vision (CV) processes to be deployed on the programmable circuitry and a host device, wherein the host device to be communicably coupled to the programmable network interface device; and access instructions to cause the portions of the set of the CV processes to be deployed on the host device and the programmable network interface device; wherein a media processing portion of the set of the CV processes is to be deployed to the programmable circuitry, and wherein the programmable circuitry is to utilize media processing hardware circuitry hosted by the apparatus to perform the media processing portion.

In Example 22, the subject matter of Example 21 can optionally include wherein the portions of the set of the CV processes to be deployed on the programmable circuitry and the host device are determined based on resource metric data collected for programmable circuitry and the host device. In Example 23, the subject matter of any one of Examples 21-22 can optionally include wherein the programmable circuitry is further to indicate identifying information to cause the portions of the set of the CV processes to be communicably coupled via a memory access protocol. In Example 24, the subject matter of any one of Examples 21-23 can optionally include wherein the media processing portion comprises one or more of decoding of data packets, encoding of the data packets, resizing of the data packets, quality modification of the data packets, or color conversion of the data packets.

In Example 25, the subject matter of any one of Examples 21-24 can optionally include wherein a first portion of the portions of the set of the CV processes is deployed on the programmable circuitry and a second portion of the portions of the set of the CV processes is deployed on the host device, and wherein the second portion that is deployed on the host device is to run an artificial intelligence (AI) model of the set of CV processes on data packets received from the first portion deployed on the programmable circuitry. In Example 26, the subject matter of any one of Examples 21-25 can optionally include wherein the data packets received by the second portion comprise decoded data packets that are decoded by the first portion at the programmable circuitry.

In Example 27, the subject matter of any one of Examples 21-26 can optionally include wherein the second portion of the set of the CV processes is to store a metadata output of the AI model in a sink designated to consume the metadata output of the set of the CV processes. In Example 28, the subject matter of any one of Examples 21-27 can optionally include wherein the identifying information comprises at least one of addresses for remote direct memory access (RDMA) or network addresses of the components, and wherein the memory access protocol comprises at least one of an RDMA protocol, a non-volatile memory express (NVMe) protocol, or a NVME over Fabrics (NVMe-oF) protocol.

In Example 29, the subject matter of any one of Examples 21-28 can optionally include wherein the host device comprises one or more of a central processing unit (CPU), a graphics processing unit (GPU), or hardware accelerator device to execution the portions of the set of the CV processes deployed on the host device. In Example 30, the subject matter of any one of Examples 21-29 can optionally include wherein the one or more processors of the programmable circuitry are to implement a CV orchestrator to cause the programmable circuitry to determine the portions and to access the instructions.

Example 31 is an apparatus for facilitating CV pipeline management in a programmable network interface device, comprising means for determining, using one or more processors of programmable circuitry of a programmable network interface device comprising a host interface and a network interface, determine portions of a set of computer vision (CV) processes to be deployed on the programmable circuitry and a host device, wherein the host device to be communicably coupled to the programmable network interface device; and means for accessing instructions to cause the portions of the set of the CV processes to be deployed on the host device and the programmable network interface device; wherein a media processing portion of the set of the CV processes is to be deployed to the programmable circuitry, and wherein the programmable circuitry is to utilize media processing hardware circuitry hosted by the apparatus to perform the media processing portion. In Example 32, the subject matter of Example 31 can optionally include the apparatus further configured to perform the method of any one of the Examples 12 to 16.

Example 33 is at least one machine readable medium comprising a plurality of instructions that in response to being executed on a computing device, cause the computing device to carry out a method according to any one of Examples 11 to 16. Example 34 is an apparatus for facilitating CV pipeline management in a programmable network interface device, configured to perform the method of any one of Examples 11 to 16. Example 35 is an apparatus for facilitating CV pipeline management in a programmable network interface device, comprising means for performing the method of any one of Examples 11 to 16. Specifics in the Examples may be used anywhere in one or more embodiments.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

What is claimed is:

1. An apparatus comprising:
a host interface;
a network interface; and
a programmable circuitry communicably coupled to the host interface and the network interface, the programmable circuitry comprising one or more processors to implement network interface functionality and to:
determine portions of a set of computer vision (CV) processes to be deployed on the programmable circuitry and a host device, wherein the host device to be communicably coupled to the programmable network interface device; and
access instructions to cause the portions of the set of the CV processes to be deployed on the host device and the programmable network interface device;
wherein a media processing portion of the set of the CV processes is to be deployed to the programmable circuitry, and wherein the programmable circuitry is to utilize media processing hardware circuitry hosted by the apparatus to perform the media processing portion.

2. The apparatus of claim 1, wherein the portions of the set of the CV processes to be deployed on the programmable circuitry and the host device are determined based on resource metric data collected for programmable circuitry and the host device.

3. The apparatus of claim 1, wherein the programmable circuitry is further to indicate identifying information to cause the portions of the set of the CV processes to be communicably coupled via a memory access protocol.

4. The apparatus of claim 1, wherein the media processing portion comprises one or more of decoding of data packets, encoding of the data packets, resizing of the data packets, quality modification of the data packets, or color conversion of the data packets.

5. The apparatus of claim 1, wherein a first portion of the portions of the set of the CV processes is deployed on the programmable circuitry and a second portion of the portions of the set of the CV processes is deployed on the host device, and wherein the second portion that is deployed on the host device is to run an artificial intelligence (AI) model of the set of CV processes on data packets received from the first portion deployed on the programmable circuitry.

6. The apparatus of claim 5, wherein the data packets received by the second portion comprise decoded data packets that are decoded by the first portion at the programmable circuitry.

7. The apparatus of claim 5, wherein the second portion of the set of the CV processes is to store a metadata output of the AI model in a sink designated to consume the metadata output of the set of the CV processes.

8. The apparatus of claim 1, wherein the identifying information comprises at least one of addresses for remote direct memory access (RDMA) or network addresses of the components, and wherein the memory access protocol comprises at least one of an RDMA protocol, a non-volatile memory express (NVMe) protocol, or a NVME over Fabrics (NVMe-oF) protocol.

9. The apparatus of claim 1, wherein the host device comprises one or more of a central processing unit (CPU), a graphics processing unit (GPU), or hardware accelerator device to execution the portions of the set of the CV processes deployed on the host device.

10. The apparatus of claim 1, wherein the one or more processors of the programmable circuitry are to implement a CV orchestrator to cause the programmable circuitry to determine the portions and to access the instructions.

11. A method comprising:
determining, by one or more processors of programmable circuitry of a programmable network interface device comprising a host interface and a network interface, determine portions of a set of computer vision (CV) processes to be deployed on the programmable circuitry and a host device, wherein the host device to be communicably coupled to the programmable network interface device; and
accessing instructions to cause the portions of the set of the CV processes to be deployed on the host device and the programmable network interface device;
wherein a media processing portion of the set of the CV processes is to be deployed to the programmable circuitry, and wherein the programmable circuitry is to utilize media processing hardware circuitry hosted by the apparatus to perform the media processing portion.

12. The method of claim 11, wherein the portions of the set of the CV processes to be deployed on the programmable circuitry and the host device are determined based on resource metric data collected for programmable circuitry and the host device.

13. The method of claim 11, further comprising indicating identifying information to cause the portions of the CV pipeline to be communicably coupled via a memory access protocol.

14. The method of claim 11, wherein the media processing portion comprises one or more of decoding of data packets, encoding of the data packets, resizing of the data packets, quality modification of the data packets, or color conversion of the data packets.

15. The method of claim 11, wherein a first portion of the portions of the set of the CV processes is deployed on the programmable circuitry and a second portion of the portions of the set of the CV processes is deployed on the host device, and wherein the second portion that is deployed on the host device is to run an artificial intelligence (AI) model of the set of CV processes on data packets received from the first portion deployed on the programmable circuitry.

16. The method of claim 15, wherein the data packets received by the second portion comprise decoded data packets that are decoded by the first portion at the programmable circuitry, and wherein the second portion of the set of the CV processes is to store a metadata output of the AI model in a sink designated to consume the metadata output of the set of the CV processes.

17. A non-transitory computer-readable medium having instructions stored thereon, which when executed by one or more processors, cause the one or more processors to perform operations that are to:
determine, by the one or more processors of programmable circuitry of a programmable network interface device comprising a host interface and a network interface, determine portions of a set of computer vision (CV) processes to be deployed on the programmable circuitry and a host device, wherein the host device to be communicably coupled to the programmable network interface device; and
access instructions to cause the portions of the set of the CV processes to be deployed on the host device and the programmable network interface device;
wherein a media processing portion of the set of the CV processes is to be deployed to the programmable circuitry, and wherein the programmable circuitry is to utilize media processing hardware circuitry hosted by the apparatus to perform the media processing portion.

18. The non-transitory computer-readable medium of claim 17, wherein the portions of the set of the CV processes to be deployed on the programmable circuitry and the host device are determined based on resource metric data collected for programmable circuitry and the host device.

19. The non-transitory computer-readable medium of claim 17, wherein the media processing portion comprises one or more of decoding of data packets, encoding of the data packets, resizing of the data packets, quality modification of the data packets, or color conversion of the data packets.

20. The non-transitory computer-readable medium of claim 17, wherein a first portion of the portions of the set of the CV processes is deployed on the programmable circuitry and a second portion of the portions of the set of the CV processes is deployed on the host device, and wherein the second portion that is deployed on the host device is to run an artificial intelligence (AI) model of the set of CV processes on data packets received from the first portion deployed on the programmable circuitry.
